(19) United States
(12) Patent Application Publication
(10) Pub. No.: US 2024/0247435 A1
(43) Pub. Date: Jul. 25, 2024

(54) LAUNDRY TREATMENT COMPOSITION INCLUDING A POLYALKYLENECARBONATE COMPOUND

(71) Applicant: The Procter & Gamble Company, Cincinnati, OH (US)

(72) Inventors: Gang SI, Newcastle upon Tyne (GB); Laura ORLANDINI, Geneva (CH); Xiaobin CHU, Beijing (CN)

(21) Appl. No.: 18/529,751

(22) Filed: Dec. 5, 2023

(30) Foreign Application Priority Data
Dec. 5, 2022 (WO) PCT/CN2022/136519

(51) Int. Cl. D06M 23/08; D06M 15/513

(52) U.S. Cl. CPC D06M 23/08; D06M 15/513

(57) ABSTRACT

A laundry treatment composition including a plurality of particles. The plurality of particles include: about 5% to about 99.9% by weight, optionally from 10% to about 99% by weight, optionally from about 30% by weight to about 95% by weight of a carrier system including a polyalkylenecarbonate compound. The composition further includes a fabric care benefit agent.

### FIELD OF THE INVENTION

The invention relates to a laundry treatment composition comprising a polyalkylenecarbonate compound and a fabric care benefit agent.

### BACKGROUND OF THE INVENTION

There is increasing consumer demand for laundry treatment compositions formulated from, substantially formulated from, or partially formulated from renewable resources. Formulations for laundry treatment compositions commonly include organic compounds as the carrier material and the benefit agent. Potential renewable sources for such carrier materials and benefit agents include biomass, water, air, and combinations thereof.

Laundry treatment compositions such as particulate laundry additives are popular with many consumers. Consumers particularly enjoy using particulate laundry additives that are delivered through the wash cycle. Particulate laundry additives are convenient for consumers to use a custom amount of the additive to achieve the desired benefit. Such additives are commonly provided in the wash along with a fully formulated detergent composition.

There is continuing desire to use more renewables in laundry treatment compositions. Laundry treatment compositions containing an appreciable fraction of renewable materials can provide a myriad of benefits.

With these needs in mind, there is a continuing unaddressed need for particulate laundry treatment compositions that are formulated from, substantially formulated from, or partially formulated from renewable resources.

### SUMMARY OF THE INVENTION

A laundry treatment composition comprising a plurality of particles, said plurality of particles comprising: about 5% to about 99.9% by weight, optionally from 10% to about 99% by weight, optionally from about 30% by weight to about 95% by weight of a carrier system comprising polyalkylenecarbonate compound (II)

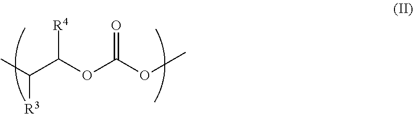

wherein, R³ and R⁴ are each independently selected from H and CH₃; and a fabric care benefit agent selected from the group of: starch; modified starch; enzyme; silicone materials; organic conditioning oils; fatty esters; metathesized unsaturated polyol esters; silane-modified oils; quaternary ammonium compound; branched polyester; fatty amine; graft copolymer; antioxidant; and antimicrobial.

### DETAILED DESCRIPTION OF THE INVENTION

A laundry treatment composition comprising a plurality of particles can be used to treat laundry using a through the wash process. In a through the wash process, the laundry treatment composition is present during the wash sub-cycle of a washing machine. A washing machine typically has a wash sub-cycle and rinse sub-cycle. Compositions designed to be delivered through the wash are convenient for the user to use. For example, the user can dispense the compositions directly to the drum of the washing machine at the time he or she places the load in the tub or starts the machine.

The particles can comprise a carrier system. The carrier system acts to carry the fabric care benefit agent to the wash liquor. Ultimately, the fabric care benefit agent is dispersed and or dissolved into the wash liquor and contacted to the laundry. Optionally, the fabric care benefit agent is deposited onto the laundry.

### Carrier System

The carrier system can comprise polyalkylenecarbonate compound comprising the following structural unit (II)

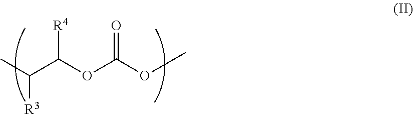

R³ and R⁴ in structure unit (II) are each independently selected from H and CH₃. The polyalkylenecarbonate compound has a molecular weight of from 120 to 200000, optionally from 150 to 100000, optionally from 180 to 50000, optionally from 210 to 25000, optionally from 240 to 10000, optionally from 270 to 8000, optionally from 300 to 4000, more optionally from 320 to 2000, optionally from 350 to 1000.

Optionally structure unit (II) is derived from copolymerization of alkylene oxide and CO₂. The alkylene oxide are selected from ethylene oxide, propylene oxide and 2,3-butylene oxide. Optionally, the alkylene oxide is selected from ethylene oxide and propylene oxide. The compound maybe synthesized under high pressure in the presence of one or more catalyst. Suitable catalyst comprises double metal cyanide (DMC) catalyst. The synthesis may be a one-step reaction or multi-step reaction. The compound may be synthesized via reaction of cyclic carbonate with a starter compound in the presence of one or more catalysts.

CO₂ from various known sources maybe used for the synthesis, including waste CO₂ captured from industrial processes, or directly from the atmosphere. The alkylene oxide can be based on fossil carbon or renewable carbon. Renewable carbon is a carbon source that avoid the use of fossil carbon such as natural gas, coal, petroleum. Typically, renewable carbon is derived from the biomass, carbon capture, or chemical recycling.

Typically, the copolymerization is carried out in the presence of a starter compound. The starter compound maybe monofunctional, difunctional, or even multifunctional.

Monofunctional starter compound include, alcohols, carboxylic acids, phenols, amines, thiols. Preferred monofunctional starter compounds are selected from alcohols and carboxylic acids.

Monofunctional starter compound include, alcohols, carboxylic acids, phenols, amines, thiols. Preferred monofunctional starter compounds are selected from alcohols and carboxylic acids. Preferably, the monofunctional starter compound comprising from 1 to 4 carbon atoms. Typical examples of monofunctional starter alcohol include, but not limit to, methanol, ethanol, propanol, butanol. Typical examples of monofunctional starter carboxylic acid include, but not limit to, formic acid, acetic acid, propionic acid and butyric acid. The monofunctional starter carboxylic acid can be saturated and unsaturated, example of unsaturated monofunctional starter carboxylic acid include acrylic acid, methacrylic acid.

Difunctional starter compound include diol, diacid, polyalkylene glycol. Examples of suitable diol include, but not limit to, ethylene glycol, propylene glycol, butylene glycol, any linear or branched, saturated or unsaturated diol C₃-C₂₂ diol. Example of suitable diol also include those contain cyclic structures, such as 1,4-cyclohexanediol, 1,4-cyclohexanedimethanol. Example of suitable acid include oxalic acid, malonic acid, succinic acid, glutaric acid, adipic acid, etc. Examples of suitable polyalkylene glycol include diethylene glycol, dipropylene glycol, triethylene glycol, tripropylene glycol, polyethylene glycol and polypropylene glycol. Suitable polyethylene glycol and polypropylene glycol have a molecular weight of from 200 to 4100, optionally from 300 to 3100, optionally 400 to 2100, optionally from 500 to 1000.

Multifunctional starter compound include compound which comprises three or more functional groups selected from —OH, —COOH, —SH, Examples of suitable multifunctional starter compound include, but not limit to, citric acid (contains 3 carboxylic acid groups and 1 hydroxyl group), glycerol (contains 3 hydroxyl groups), and sugar alcohols such as sorbitol, mannitol, etc.

The total weight percentage of CO₂ (CO₂ wt %) in the polyalkylenecarbonate compound is from 5% to 70%, optionally from 10% to 60%, optionally from 15% to 55%, optionally from 20% to 50%, most preferable form 25% to 45%. The total weight percentage (wt %) of CO₂ in the polyalkylenecarbonate compound is calculated using the following formula:

$${CO}_{2} wt \% = \frac{average mole of {CO}_{2} in the compound \times 44}{average molecular weight of the compound} \times 100 \%$$

The polyalkylenecarbonate compound are water soluble. Optionally the polyalkylenecarbonate compound has solubility of more than 1g/L in DI water (25 C). Optionally more than 5g/L in DI water (25 C), optionally more than 10g/L in DI water (25 C.).

Once dissolved DI water, the polyalkylenecarbonate compound may or may not reduce surface tension. In certain embodiment, it maybe preferred the polyalkylenecarbonate compound reduce the surface tension of water to below 60 mN/m, optionally below 50 mN/m, optionally below 50 mN/m, and optionally below 40 mN/m, and optionally below 35 mn/m. The surface tension is measured at concentration of 5000 ppm in DI water.

The polyalkylenecarbonate compound maybe biodegradable or non-biodegradable. Optionally, the polyalkylenecarbonate compound has the following structure (I):

R¹{-L-[A]ₓ-[B]_{y}—R²}_{z} - - - (I)

Wherein,
R¹ is a residue derived from a starter compound;
   wherein, the starter compound is selected from monofunctional starter compound comprising from 1 to 4 carbon atoms, difunctional starter compound, multifunctional starter compound;
R² is each independently selected from H, linear or branched, substituted or unsubstituted C₁-C₄ alkyl;
L is selected from O, (C═O)—O, a single bond;
A has the following structural unit (II)

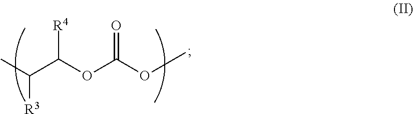

B has the following structural unit (III)

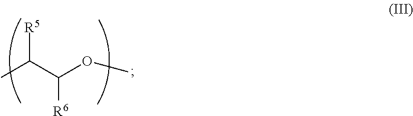

R³, R⁴, R⁵, R⁶ are each independently selected from H and CH₃;
x is integer each independently in the range of 1 to 250;
y is integer each independently in the range of 0 to 250;
z is integer each independently in the range of 1 to 20.

Optionally, x is in the range of 2 to 200, optionally 3 to 150, optionally 4 to 100, optionally 5 to 75, optionally 5 to 50, optionally between 1 to 25. Optionally, y is in the range of 0 to 200, optionally 2 to 150, optionally 3 to 100, optionally 5 to 75, optionally 5 to 50. Optionally z is in the range of 1 to 10, optionally 1 to 5, optionally z is 1, 2 or 3.

When L is a single bond, R¹ is connected to (II) or (III) from right side as indicated below:

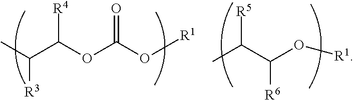

When L is O and/or (C═O)—O, R¹ is connected to the L, and L is further connected to (II) or (III) from the left side as indicated below:

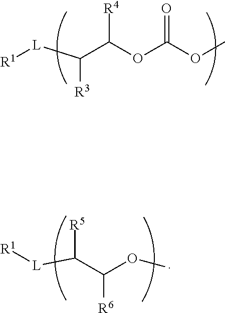

When the polyalkylenecarbonate compound comprise both A structural unit and B structural unit, it is understood that the A and B structural units can be arranged blockwise, alternating, periodically and/or statistically. It is preferred that structural unit A and B of the polyalkylenecarbonate compound are arranged blockwise, such as di-block, tri-block.

Below are some representative examples to clarify meaning of blockwise:

A di-block polyalkylenecarbonate compound containing six A structural units and six B structural units may be represented using structure below:

R¹{-L-[AAAAAA]-b-[BBBBBB]—R²}_{z}.

A tri-block polyalkylenecarbonate compound containing six A structural units and six B structural units can be represented with structure below:

R¹{-L-[AAA]-b-[BBBBB]-b-[AAA]-R²}_{z}.

The polyalkylenecarbonate compound has a molecular weight of from 120 to 200000, optionally from 150 to 150000, optionally from 200 to 100000, optionally from 250 to 50000, optionally from 300 to 25000, optionally from 350 to 15000, optionally from 400 to 10000, optionally from 450 to 9000, optionally from 500 to 8000, and the polyalkylenecarbonate compound is water soluble.

Optionally, the total weight percentage of CO₂ (CO₂ wt %) in the polyalkylenecarbonate compound is from 5% to 70%, optionally from 10% to 60%, optionally from 15% to 55%, optionally from 20% to 50%, optionally from 25% to 45%.

In one embodiment, R¹ is a linear or branched, substituted or unsubstituted C₁-C₄ alkyl; R² is H; L is O; z is 1; the polyalkylenecarbonate compound has a structure of (IV):

R¹—O-[A]ₓ-[B]_{y}—H - - - (IV).

Depending on the value of x, y and how A and B are arranged, the compound can be di-block, tri-block, tetra-block, and multi-block. Optionally, the compound is di-block and tri-block. Examples di-block compounds include (IV-1) to (IV-4):

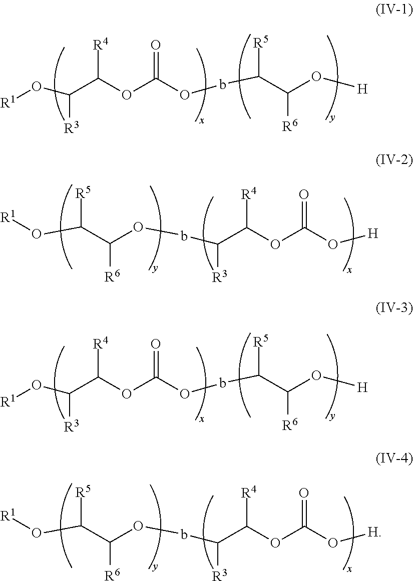

Examples of tri-block compounds include (IV-5) and (IV-6):

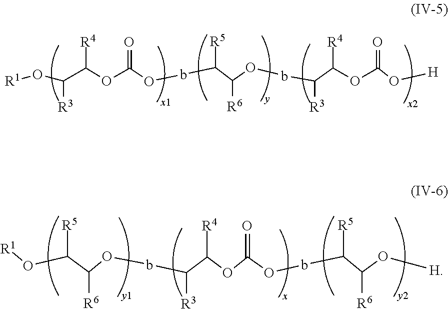

Wherein, x1 and x2 integer each independently of at least 1; x1+x2=x.

In another embodiment, R¹ is a linear or branched C₁-C₄ alkyl; R² is a linear or branched C₁-C₄ alkyl; L is O; z is 1; the polyalkylenecarbonate compound has a structure of (V):

R¹—O-[A]ₓ-[B]_{y}—R² - - - (V).

Depending on the value of x, y and how A and B are arranged, the compound can be di-block, tri-block and tetra-block. Optionally, the compound is di-block and tri-block. Examples di-block compounds include (V-1) and (V-2):

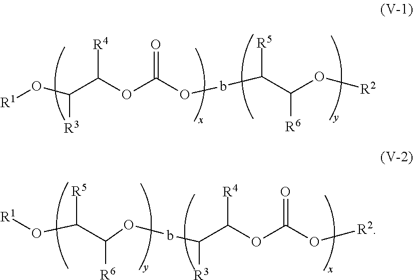

Examples of tri-block compound include (V-3) and (V-4):

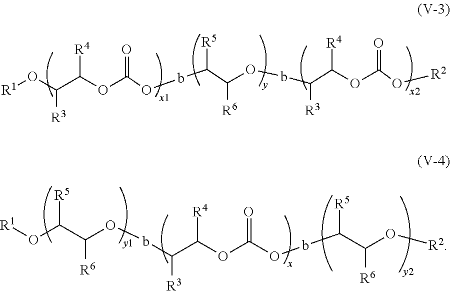

Wherein, x1 and x2 integer each independently of at least 1; x1+x2=x.

Representative examples of R¹ and R² (if R² is not H) and linear and branched, unsubstituted C₁-C₄ alkyl include, methyl, ethyl, n-propyl, n-butylisopropyl, isobutyl, and t-butyl.

One specific example under this embodiment is the following: R¹ is C₁ alkyl (Methyl), R² is H, L is O, the polyalkylenecarbonate compound has a structure of (VI-1) or (VI-2).

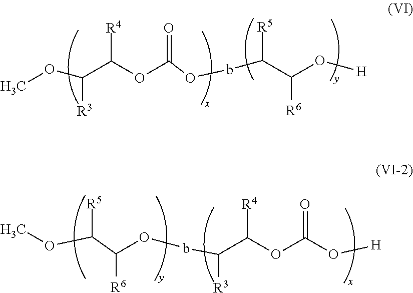

Preferably, polyalkylenecarbonate compound has a structure of (VI-2). Such structure can be derived using polyalkylene glycol mono methyl ether as initiator, preferred mono methyl ether is poly(ethylene glycol) monomethyl ether (mPEG). Preferred mPEG have weight average molecular weight of 200 to 9000, examples include mPEG200, mPEG800, mPEG2000, mPEG 3000, mPEG4000, mPEG5000, mPEG6000, mPEG7000, mPEG8000.

Where total number of x and y is from 2 to 40, optionally from 3 to 30, optionally from 4 to 20, optionally from 5 to 50.

Another specific example under this embodiment is the following: R¹ is C₁-C₄ alkyl, R² is H, L is COO, the polyalkylenecarbonate compound has a structure of (VI-3):

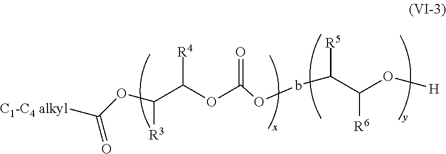

Where total number of x and y is from 2 to 40, optionally from 3 to 30, optionally from 4 to 20, optionally from 5 to 50.

In another embodiment, R¹ is derived from a difunctional or multifunctional starter compound; R² is H; L is O and/or (C═O)—O; z is at least 2. An example polyalkylenecarbonate compound derived from difunctional starter compound has a structure of (VII):

{R²—[B]_{y}-[A]ₓ-L-}R¹{-L-[A]ₓ-[B]_{y}—R²}- - - (VII).

Where R¹ is derived from a difunctional starter compound.

Optionally, R¹ is derived from polyalkylene glycol including diethylene glycol, dipropylene glycol, triethylene glycol, tripropylene glycol, polyethylene glycol and polypropylene glycol. Optionally, R¹ is derived from polyethylene glycol or polypropylene glycol have a molecular weight of from 200 to 4100, optionally from 300 to 3100, optionally 400 to 2100, optionally from 500 to 1000.

When R¹ is selected from polyethylene glycol, the polyalkylenecarbonate compound has a structure of (VII-1)

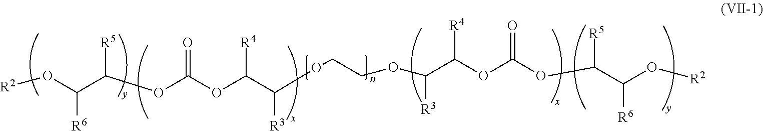

wherein, n is the number of ethylene glycol units of the polyethylene glycol.

It maybe preferred that R¹ is derived from polypropylene glycol. The structural unit Λ and B in the structure (VII-1) maybe arranged randomly or blockwise.

An example polyalkylenecarbonate compound derived from multifunctional starter compound has a structure of (VIII):

R¹{-L-[A]ₓ-[B]_{y}—R²}_{z} - - - (VIII)

Where z is from 3 to 10, more preferably 3 to 5, most preferably 3, 4, or 5.

Where R¹ is derived from a multifunctional starter compound. Preferred examples of multifunctional starter compound include, but no limit to, glycerol, 1,1,1-trimethylolpropane (TMP), citric acid.

As described herein, the term polyalkylenecarbonate can also be referred as polyalkylene carbonate and other terms that represent the same structure.

The carrier systems can further comprise a carrier material selected from the group of water soluble inorganic alkali metal salt, water-soluble alkaline earth metal salt, water-soluble organic alkali metal salt, water-soluble organic alkaline earth metal salt, water soluble carbohydrate, water-soluble silicate, water soluble urea, and any combination thereof.

Alkali metal salts can be, for example, selected from salts of lithium, salts of sodium, and salts of potassium, and any combination thereof. Useful alkali metal salts can be, for example, selected from alkali metal fluorides, alkali metal chlorides, alkali metal bromides, alkali metal iodides, alkali metal sulfates, alkali metal bisulfates, alkali metal phosphates, alkali metal monohydrogen phosphates, alkali metal dihydrogen phosphates, alkali metal carbonates, alkali metal monohydrogen carbonates, alkali metal acetates, alkali metal citrates, alkali metal lactates, alkali metal pyruvates, alkali metal silicates, alkali metal ascorbates, and combinations thereof.

Alkali metal salts can be selected from sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium acetate, sodium citrate, sodium lactate, sodium tartrate, sodium silicate, sodium ascorbate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium acetate, potassium citrate, potassium lactate, potassium tartrate, potassium silicate, potassium, ascorbate, and combinations thereof.

Alkaline earth metal salts can be selected from salts of magnesium, salts of calcium, and the like, and combinations thereof. Alkaline earth metal salts can be selected from alkaline metal fluorides, alkaline metal chlorides, alkaline metal bromides, alkaline metal iodides, alkaline metal sulfates, alkaline metal bisulfates, alkaline metal phosphates, alkaline metal monohydrogen phosphates, alkaline metal dihydrogen phosphates, alkaline metal carbonates, alkaline metal monohydrogen carbonates, alkaline metal acetates, alkaline metal citrates, alkaline metal lactates, alkaline metal pyruvates, alkaline metal silicates, alkaline metal ascorbates, and combinations thereof. Alkaline earth metal salts can be selected from magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium acetate, magnesium citrate, magnesium lactate, magnesium tartrate, magnesium silicate, magnesium ascorbate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, and combinations thereof.

Inorganic salts, such as inorganic alkali metal salts and inorganic alkaline earth metal salts, do not contain carbon. Organic salts, such as organic alkali metal salts and organic alkaline earth metal salts, contain carbon. The organic salt can be an alkali metal salt or an alkaline earth metal salt of sorbic acid (i.e., a sorbate). Sorbates can be selected from sodium sorbate, potassium sorbate, magnesium sorbate, calcium sorbate, and combinations thereof.

The carrier system can comprise a carrier material selected from the group of water-soluble inorganic alkali metal salt, water-soluble organic alkali metal salt, water-soluble inorganc alkaline earth metal salt, water-soluble organic alkaline earth metal salt, water-soluble carbohydrate, water-soluble silicate, water-soluble urea, and combinations thereof. The carrier system can further comprise sodium chloride, potassium chloride, calcium chloride, magnesium chloride, sodium sulfate, potassium sulfate, magnesium sulfate, sodium carbonate, potassium carbonate, sodium hydrogen carbonate, potassium hydrogen carbonate, sodium acetate, potassium acetate, sodium citrate, potassium citrate, sodium tartrate, potassium tartrate, potassium sodium tartrate, calcium lactate, water glass, sodium silicate, potassium silicate, dextrose, fructose, galactose, isoglucose, glucose, sucrose, raffinose, isomalt, xylitol, candy sugar, coarse sugar, and combinations thereof. In one embodiment, the carrier system can comprise sodium chloride. In one embodiment, the carrier can comprise table salt.

The carrier system can comprise a carrier material selected from the group of sodium bicarbonate, sodium sulfate, sodium carbonate, sodium formate, calcium formate, sodium chloride, sucrose, maltodextrin, corn syrup solids, corn starch, wheat starch, rice starch, potato starch, tapioca starch, clay, silicate, citric acid carboxymethyl cellulose, fatty acid, fatty alcohol, glyceryl diester of hydrogenated tallow, glycerol, and combinations thereof.

The carrier system can comprise a carrier material selected from the group of water soluble organic alkali metal salt, water soluble inorganic alkaline earth metal salt, water soluble organic alkaline earth metal salt, water soluble carbohydrate, water soluble silicate, water soluble urea, starch, clay, water insoluble silicate, citric acid carboxymethyl cellulose, fatty acid, fatty alcohol, glyceryl diester of hydrogenated tallow, glycerol, polyethylene glycol, and combinations thereof.

The carrier system can comprise a carrier material selected from the group of disaccharides, polysaccharides, silicates, zeolites, carbonates, sulfates, citrates, and combinations thereof. The carrier system can comprise a carrier material selected from the group of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.

The carrier system can comprise a water soluble polymer. The water soluble polymer can be selected from C₈-C₂₂ alkyl polyalkoxylate comprising more than about 40 alkoxylate units, ethoxylated nonionic surfactant having a degree of ethoxylation greater than about 30, polyalkylene glycol having a weight average molecular weight from about 2000 to about 15000, and combinations thereof.

The carrier system can comprise a carrier material that is a water soluble polymer. The water soluble polymer can be a block copolymer having Formulae (I), (II), (III) or (IV), R¹O-(EO)x-(PO)y-R² (I), R¹O—(PO)x-(EO)y-R² (II), R¹O-(EO)o-(PO)p-(EO)q-R² (III), R¹O—(PO)o-(EO)p-(PO)q-R² (IV), or a combination thereof; wherein EO is a —CH CH₂O— group, and PO is a —CH(CH₃)CH₂O— group; R¹ and R² independently is H or a C₁-C₂₂ alkyl group; x, y, o, p, and q independently is 1-100; provided that the sum of x and y is greater than 35, and the sum of o, p and q is greater than 35; wherein the block copolymer has a molecular weight ranging from about 3000 g/mol to about 15,000 g/mol.

The carrier system can comprise a carrier material that is a block copolymer or block copolymers, for example a block copolymer based on ethylene oxide and propylene oxide selected from PLURONIC-F38, PLURONIC-F68, PLURONIC-F77, PLURONIC-F87, PLURONIC-F88, and combinations thereof. PLURONIC materials are available from BASF.

The carrier system can comprise a carrier material selected from the group of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; cellulose, alkyl cellulosics such as methyl cellulose, ethyl cellulose and propyl cellulose; cellulose ethers; cellulose esters; cellulose amides; polyvinyl acetates; polycarboxylic acids and salts; polyaminoacids or peptides; polyamides; polyacrylamide; copolymers of maleic/acrylic acids; polysaccharides including starch, modified starch (suitable modified starches for use include, but are not limited to, COLLAMIDON 8805 commercially available from AGRANA Starch, Gmuend, Austria, and CTEX 06219, commercially available from Cargill B.V., Netherlands); gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth; and combinations thereof. In one embodiment the polymer comprises polyacrylates, especially sulfonated polyacrylates and water-soluble acrylate copolymers; and alkylhydroxy cellulosics such as methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates. In yet another embodiment the water soluble polymer can be selected from PVA; PVA copolymers; hydroxypropyl methyl cellulose (HPMC); and mixtures thereof.

The carrier system can comprise a carrier material selected from the group of polyvinyl alcohol, modified polyvinyl alcohol, polyvinyl pyrrolidone, polyvinyl alcohol/polyvinyl pyrrolidone, polyvinyl alcohol/polyvinyl amine, partially hydrolyzed polyvinyl acetate, polyalkylene oxide, polyethylene glycol, acrylamide, acrylic acid, cellulose, alkyl cellulosics, methyl cellulose, ethyl cellulose, propyl cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides, starch, modified starch, gelatin, alginates, xyloglucans, hemicellulosic polysaccharides, xylan, glucuronoxylan, arabinoxylan, mannan, glucomannan, galactoglucomannan, natural gums, pectin, xanthan, carrageenan, locus bean, arabic, tragacanth, polyacrylates, sulfonated polyacrylates, water-soluble acrylate copolymers, alkylhydroxy cellulosics, methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates, polyvinyl alcohol copolymers, hydroxypropyl methyl cellulose, and mixtures thereof. The carrier system can comprise a carrier material that is an organic material. Organic water soluble polymers may provide a benefit of being readily soluble in water.

The carrier system can comprise a carrier material selected from polyethylene glycol, polypropylene glycol polyoxoalkylene, polyethylene glycol fatty acid ester, polyethylene glycol ether, starch, and mixtures thereof.

The carrier material can comprise polyethylene glycol (PEG). PEG can be a convenient material to employ to make particles because it can be sufficiently water soluble to dissolve during a wash cycle when the particles have the range of mass disclosed herein. Further, PEG can be easily processed as melt. The onset of melt temperature of PEG can vary as a function of molecular weight of the PEG. The carrier system can comprise PEG having a weight average molecular weight from about 2000 to about 15000. PEG has a relatively low cost, may be formed into many different shapes and sizes, minimizes unencapsulated perfume diffusion, and dissolves well in water. PEG comes in various weight average molecular weights. A suitable weight average molecular weight range of PEG includes from about 2,000 to about 13,000, alternatively from about 4,000 to about 13,000, alternatively from about 4,000 to about 12,000, alternatively from about 4,000 to about 11,000, alternatively from about 5,000 to about 11,000, alternatively from about 6,000 to about 10,000, alternatively from about 7,000 to about 9,000, alternatively combinations thereof. PEG is available from BASF, for example PLURIOL E 8000, or other PLURIOL product. The carrier material can comprise a mixture of two or more polyethylene glycol compositions, one having a first weight average molecular weight (e.g. 9000) and the other having a second weight average molecular weight (e.g. 4000), the second weight average molecular weight differing from the first weight average molecular weight.

The plurality of particles can comprise about 5% to about 99.9% by weight of a carrier system comprising polyalkylenecarbonate compound (II). Optionally, the plurality of particles can comprise about 10% to about 99% by weight of a carrier system comprising polyalkylenecarbonate compound (II). Optionally, the plurality of particles can comprise about 30% to about 95% by weight of a carrier system comprising polyalkylenecarbonate compound (II). The plurality of particles can comprise any whole percentages or ranges of whole percentages within any of the aforementioned ranges, of a carrier system by weight of the plurality of particles.

The carrier system can comprise a carrier material selected from: a polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200; a polyethylene glycol fatty acid ester of formula (C₂H₄O)_{q}—C(O)O—(CH₂)ᵣ—CH₃ wherein q is from about 20 to about 200 and r is from about 10 to about 30; a polyethylene glycol fatty alcohol ether of formula HO—(C₂H₄O)ₛ—(CH₂)ₜ)—CH₃ wherein s is from about 30 to about 250 and t is from about 10 to about 30; and mixtures thereof. The polyalkylene polymer of formula H—(C₂H₄O)ₓ—(CH(CH₃)CH₂O)_{y}—(C₂H₄O)_{z}—OH wherein x is from about 50 to about 300, y is from about 20 to about 100, and z is from about 10 to about 200, can be a block copolymer or random copolymer.

The carrier system can comprise a carrier material selected from: polyethylene glycol; a polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200; a polyethylene glycol fatty acid ester of formula (C₂H₄O)_{q}—C(O)O—(CH₂)ᵣ-CH₃ wherein q is from about 20 to about 200 and r is from about 10 to about 30; and a polyethylene glycol fatty alcohol ether of formula HO—(C₂H₄O)ₛ—(CH₂)ₜ)—CH₃ wherein s is from about 30 to about 250 and t is from about 10 to about 30.

The carrier system can further comprise from about 20% to about 95% by weight of the plurality of particles or by weight of the individual particles of a carrier material that is a polyalkylene polymer of formula H—(C₂H₄O)ₓ—(CH(CH₃)CH₂O)_{y}—(C₂H₄O)_{z}—OH wherein x is from about 50 to about 300; y is from about 20 to about 100, and z is from about 10 to about 200.

The carrier system can comprise from about 1% to about 20% by weight of the plurality of particles or by weight of the individual particles a carrier material that is a polyethylene glycol fatty acid ester of formula (C₂H₄O)_{q}—C(O)O—(CH₂)ᵣ—CH₃ wherein q is from about 20 to about 200 and ris from about 10 to about 30.

The carrier system can comprise from about 1% to about 10% by weight of the plurality of particles or by weight of the individual particles of a carrier material that is a polyethylene glycol fatty alcohol ether of formula HO—(C₂H₄O)ₛ—(CH₂)ₜ)—CH₃ wherein s is from about 30 to about 250 and t is from about 10 to about 30.

To help manage the water in a melt of water soluble polymer forming part of the carrier system, it can be practical to provide an anhydrous salt to the melt. Anhydrous salts have a propensity to hydrate with water from the surrounding environment. The anhydrous salt can be selected based on the melt processing conditions. For melt processing particulate laundry scent additives, the perfume portion of the laundry scent additive can influence the selection of the anhydrous salt.

There are a variety of anhydrous salts that hydrate into a salt hydrate and the resulting salt hydrate has a salt hydrate onset of melt above the polyalkylenecarbonate compound onset of melt that is useful in particulate laundry scent additives. Of these salt hydrates there are some that have a salt hydrate onset of melt that is also below the flash point and boiling point of the perfume. By using a salt hydrate that has a salt hydrate onset of melt that is between the polyalkylenecarbonate compound onset of melt and the flash point or boiling point of the perfume, there is a temperature range within which the melt of polyalkylenecarbonate compound, perfume, and salt hydrate are melt processable. Further, the salt hydrate can be provided to the melt by introducing an anhydrous salt of the salt hydrate. The anhydrous salt can acquire water in the melt when the anhydrous salt hydrates into a salt hydrate. Moreover, the since hydration occurs above the polyalkylenecarbonate compound onset of melt, the composition remains melt processable since the water soluble polymer dominates the rheological properties of the melt. If the salt hydrate onset of melt is below the polyalkylenecarbonate compound onset of melt, once the temperature of the particle reaches a temperature of the salt hydrate onset of melt, the salt hydrate will release its water and the water may dissolve at least some of the polyalkylenecarbonate compound, which results in an unstable particle.

The amount of anhydrous salt added to a melt that includes water can be computed based on the amount of water in the melt to be managed. The water is managed by the anhydrous salt hydrating into its salt hydrate, thereby acquiring the water being managed. For example, sodium acetate anhydrous, upon exposure to water, can hydrate into sodium acetate trihydrate. This means that 1 mol of sodium acetate anhydrous can combine with 3 mol of water. With knowledge of the amount of water in the melt to be managed, the amount of anhydrous salt added, which ultimately ends up as a salt hydrate, can be determined.

The salt hydrate can be formed by anhydrous salt being introduced into a melt comprising the water soluble polymer, perfume, and water.

The salt hydrate can have an onset of melt greater than 40 C. Salt hydrates having such an onset of melt can be practical since 40 C is a temperature representative of the temperatures that finished particles might be exposed to during shipping and storage. The salt hydrate will tend to melt at a temperature greater than its onset of melt, which can result in instability of the particles.

The salt hydrate can be selected from the group consisting of: calcium chloride tetrahydrate, calcium nitrate tetrahydrate, zinc nitrate trihydrate, zinc nitrate dihydrate, potassium fluoride dihydrate, iron nitrate nonahydrate, sodium dihydrogen phosphate heptahydrate, sodium dihydrogen phosphate dihydrate, sodium acetate trihydrate, sodium aluminum sulfate dodecahydrate, aluminum nitrate nonahydrate, lithium acetate dihydrate, sodium phosphate dodecahydrate, sodium thiosulfate pentahydrate, tetrasodium pyrophosphate decahydrate, barium hydroxide octahydrate, aluminum sulfate octadecahydrate, magnesium carbonate trihydrate, magnesium nitrate hexahydrate, magnesium nitrate dihydrate, magnesium sulfate heptahydrate, magnesium chloride hexahydrate, and combinations thereof.

The salt hydrate can be sodium acetate trihydrate. Sodium acetate trihydrate can have an onset of melt of about 58 C.

The plurality of particles can comprise from about 1% to about 40% by weight salt hydrate. Optionally, the plurality of particles can comprise from about 1% to about 30%, or even from about 1% to about 20%, or even from about 1% to about 10%, by weight salt hydrate. The plurality of particles can further comprise acid. The acid can lower the pH of the particles, which may help to prevent discoloration of the particle. For example, sodium acetate trihydrate can tend to raise the pH of the particle and acid can be used to lower the pH. The particles can comprise from about 0.5% to about 5% by weight acid. The acid can be selected from the group consisting of citric acid, formic acid, and mixtures thereof.

### Antioxidant

The plurality of particles can comprise an antioxidant as the fabric care benefit agent. Particles that include antioxidant can provide for malodor reduction by retarding autoxidation events in remaining soils even after the laundry has been washed. The autoxidation can lead to the formation of malodorous materials.

The plurality of particles can comprise from about 0.01% to about 50, optionally from about 0.05% to 2%, optionally 0.2% to 1.5%, optionally 0.1% to 1%, optionally 0.2% to 1%, optionally from about 0.4% to about 1.5%, by weight antioxidant. The antioxidant can be selected from alkylated phenols, aryl amines, and mixtures thereof. Antioxidants are substances as described in Kirk-Othmer (Vol. 3, page 424) and in Ullmann's Encyclopedia (Vol. 3, page 91).

Alkylated phenols may have the general formula:

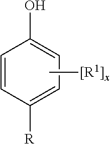

wherein R¹ is a C₃-C₆ branched alkyl, optionally tert-butyl; x is 1 or 2, optionally x is 2; at least one R¹ is ortho to the OH group, optionally when x is 2, both R¹ are ortho to the OH group; R is selected from —OH, C₂-C₂₂ linear alkyl, C₃-C₂₂ branched alkyl, and (CₙH₂ₙ)_{y}(CO₂)R², where the index n is 1 to 6, optionally n is 1 to 3, optionally n is 2, the index y is 0 or 1, optionally y is 1; R² is selected from C₁-C₈ linear alkyl, C₃-C₈ branched alkyl, and (CₘH₂ₘO)_{z}R³ where each m is independently 1 to 4, optionally each m is independently 2 or 3, the index z is 1 to 20, R³ is H or C₁-C₄ linear alkyl; optionally R² is C₁-C₁₈ linear alkyl or C₃-C₁₈ branched alkyl, optionally R² is C₁-C₄ linear alkyl or C₃-C₈ branched alkyl, optionally R² is methyl.

Alkylated phenols may also have the general formula:

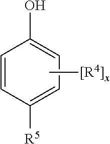

wherein x is 1 or 2, optionally 2;
each R⁴ is independently selected from C₁-C₆ linear alkyl, and C₃-C₁₆ branched alkyl, provided when x is 2, at least one R⁴ in the alkylated phenol is not t-butyl, optionally C₁-C₆ linear alkyl, optionally methyl; optionally one R⁴ is C₃-C₁₆ branched alkyl, optionally t-butyl; optionally, one R⁴ is methyl and the other R⁴ is t-butyl;
wherein at least one R⁴ is positioned on the ring ortho to a hydroxyl group, optionally both R⁴ are ortho to a hydroxyl group;
R⁵ is selected from C₁-C₂₂ linear alkyl, C₃-C₂₂ branched alkyl, (CᵣH₂ᵣO)_{w}R⁹ where each r is independently 1 to 4, the index w is 1 to 20, R⁹ is H or C₁-C₄ linear alkyl, and (CₙH₂ₙ)_{y}C(O)QR⁶, where Q is independently selected from —O—, —S—, and —NR⁷—, wherein R⁷ is selected from H and C₁-C₄ alkyl, optionally R⁷ is H; where the index n is 1 to 6, optionally n is 2 or 3, the index y is 0 or 1, optionally 1; optionally R⁵ is (CₙH₂ₙ)_{y}C(O)QR⁶ wherein Q is —O—, n is 2 or 3, and y is 1; R⁶ is selected from C₁-C₈ linear alkyl, C₃-C₈ branched alkyl, and GR⁸ wherein G is a divalent organic moiety with weight from 12 to 1,443 Da, optionally from 12 to 300, optionally G is selected from (CH₂)ₚQ where the index p is from 2 to 12 and (CₘH₂ₘO)—, where each m is independently 1 to 4, m is 2 or 3, optionally m is 2, the index z is 1 to 20; optionally G is (CₘH₂ₘO)_{z}, where each m is 2, the index z is 2 to 6; R⁸ is H, C₁-C₄ linear alkyl, C(O)(CₙH₂ₙ)_{y}C₆H₄(R⁴)ₓOH, and mixtures thereof, wherein n, y, x and R⁴, which are independently selected for R⁸, are defined as above.

Alkylated phenols may also have the general formula:

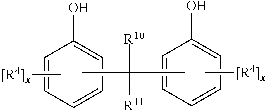

wherein each index x is independently 1 or 2;
each R⁴ is independently selected from C₁-C₆ linear alkyl, optionally methyl, and C₃-C₁₆ branched alkyl, optionally t-butyl; wherein each R⁴ is positioned either ortho- or para- to the OH group on its ring, and wherein the two points of attachment of the —CR¹⁰R¹¹— bridge are ortho-, para-, or a mixture thereof, optionally both either ortho- or both para-, to the OH on the aryl rings to which the bridge is joined; R¹⁰ and R¹¹ are individually selected from H and C₁-C₆ linear alkyl, optionally H and methyl, optionally R¹⁰ and R¹¹ are H.

The alkylated phenol may be a hindered phenol. As used herein, the term hindered phenol is used to refer to a compound comprising a phenol group with either (a) at least one C₃ or higher branched alkyl, optionally a C₃-C₆ branched alkyl, optionally tert-butyl, attached at a position ortho to at least one phenolic —OH group, or (b) substituents independently selected from C₁-C₆ alkoxy, optionally methoxy, C₁-C₂₂ linear alkyl or C₃-C₂₂ branched alkyl, optionally methyl or branched C₃-C₆ alkyl, or mixtures thereof, at each position ortho to at least one phenolic —OH group. If a phenyl ring comprises more than one —OH group, the compound is a hindered phenol provided at least one such —OH group is substituted as described immediately above.

Suitable phenols for use herein may include, but are not limited to, those selected from 3,5-bis(1,1-dimethylethyl)-4-hydroxy-benzenepropanoic acid, methyl ester; d-tocopherol; 2,6-bis(1-methylpropyl)phenol; 2-(1,1-dimethylethyl)-1,4-benzenediol; 2,5-bis(1,1-dimethylethyl)-1,4-benzenediol; 2,6-bis(1,1-dimethylethyl)-1,4-benzenediol; 2,4-bis(1,1-dimethylethyl)-phenol; 2,6-bis(1,1-dimethylethyl)-phenol; 2-(1,1-dimethylethyl)-4-methylphenol; 2-(1,1-dimethylethyl)-4,6-dimethyl-phenol; 3,5-bis(1,1-dimethylethyl)-4-hydroxybenzenepropanoic acid, 1,1′-[2,2-bis[[3-[3,5-bis(1, 1-dimethylethyl)-4-hydroxyphenyl]-1-oxopropoxy]methyl]-1,3-propanediyl] ester; 2,2′-methylenebis[6-(1,1-dimethylethyl)-4-methylphenol; 2-(1,1-dimethylethyl)-phenol; 2,4,6-tris(1,1-dimethylethyl)-phenol; 4,4′-methylenebis]2,6-bis(1, 1-dimethylethyl)-phenol; 4,4′,4″-[(2,4,6-trimethyl-1,3,5-benzenetriyl)tris(methylene)]tris[2,6-bis(1,1-dimethylethyl)-phenol]; N,N-1,6-hexanediylbis[3,5-bis(1,1-dimethylethyl)-4-hydroxybenzenepropanamide; 3,5-bis(1,1-dimethylethyl)-4-hydroxybenzoic acid, hexadecyl ester; P-[[3,5-bis(1,1-dimethylethyl)-4-hydroxyphenyl]methylphosphonic acid, diethyl ester; 1,3,5-tris[[3,5-bis(1,1-dimethylethyl)-4-hydroxyphenyl]methyl]-1,3,5-triazine-2,4,6(1H,3H,5H)-trione; 3,5-bis(1,1-dimethylethyl)-4-hydroxybenzenepropanoic acid, 2-[3-[3,5-bis(1, 1-dimethylethyl)-4-hydroxyphenyl]-1-oxopropyl]hydrazide; 4-[(dimethylamino)methyl]-2,6-bis(1,1-dimethylethyl)phenol;4-[[4,6-bis(octylthio)-1,3,5-triazin-2-yl ]amino]-2,6-bis(1,1-dimethylethyl)phenol; 3,5-bis(1,1-dimethylethyl)-4-hydroxybenzenepropanoic acid, 1,1′-(thiodi-2,1-ethanediyl) ester; 3,5-bis(1,1-dimethylethyl)-4-hydroxybenzoic acid, 2,4-bis(1,1-dimethylethyl)phenyl ester; 3,5-bis(1,1-dimethylethyl)-4-hydroxybenzenepropanoic acid, 1,1′-(1,6-hexanediyl)ester; 3-(1,1-dimethylethyl)-β-[3-(1,1-dimethylethyl)-4-hydroxyphenyl]-4-hydroxy-β-methylbenzenepropanoic acid, 1,1′-(1,2-ethanediyl) ester; 2-[[3,5-bis(1,1-dimethylethyl)-4-hydroxyphenyl]methyl]-2-butylpropanedioic acid, 1,3-bis(1,2,2,6,6-pentamethyl-4-piperidinyl) ester; 3,5-bis(1,1-dimethylethyl)-4-hydroxybenzenepropanoic acid, 1-[2-[3-[3,5-bis(1,1-dimethylethyl)-4-hydroxyphenyl]-1-oxopropoxy ]ethyl]-2,2,6,6-tetramethyl-4-piperidinyl ester; 3,4-dihydro-2,5,7,8-tetramethyl-2-[(4R,8R)-4,8,12-trimethyltridecyl]-(2R)-2H-1-benzopyran-6-ol; 2,6-dimethylphenol; 2,3,5-trimethyl-1,4-benzenediol; 2,4,6-trimethylphenol; 2,3,6-trimethylphenol; 4,4′-(1-methylethylidene)-bis[2,6-dimethylphenol]; 1,3,5-tris[[4-(1,1-dimethylethyl)-3-hydroxy-2,6-dimethylphenyl]methyl]-1,3,5-triazine-2,4,6(1H,3H,5H)-trione; 4,4′-methylenebis[2,6-dimethylphenol]; 2,6-bis(1-methylpropyl)phenol; and mixtures thereof.

Additional phenols suitable for use herein may include, but are not limited to, those selected from 2-(1,1-dimethylethyl)-4-methylphenol; 2-(1,1-dimethylethyl)-4,6-dimethyl phenol; 2,4-bis(1,1-dimethylethyl)-6-methyl phenol; 2,4-bis(1,1-dimethylethyl)-6-ethyl phenol; 2,4-dimethyl-6-(1-methylpentadecyl) phenol; 2,4-dimethyl-6-(1,1,3,3-tetramethylbutyl) phenol; 4-(1,1-dimethylethyl)-2-methyl-6-(1-methylpentadecyl) phenol; 4-(1,1-dimethylethyl)-2-methyl-6-(1,1,3,3-tetramethylbutyl) phenol; 3-(1,1-dimethylethyl)-4-hydroxy-5-methyl benzenepropanoic acid, isooctyl ester; 3-(1,1-dimethylethyl)-4-hydroxy-5-methyl benzenepropanoic acid, methyl ester; 3-(1,1-dimethylethyl)-4-hydroxy-α,5-dimethyl benzenepropanoic acid, methyl ester; 3-(1,1-dimethylethyl)-4-hydroxy-α,5-dimethyl benzenepropanoic acid, ethyl ester; 3-(1,1-dimethylethyl)-4-hydroxyα,α,5-trimethyl benzenepropanoic acid, methyl ester; 3-(1,1-dimethylethyl)-4-hydroxy-5-methyl benzenepropanoic acid, 1,1′-[1,2-ethanediylbis(oxy-2,1-ethanediyl)] ester; 3-(1,1-dimethylethyl)-4-hydroxy-α,5-dimethyl benzenepropanoic acid, 1,1′-[1,2-ethanediylbis(oxy-2,1-ethanediyl)] ester; N,N′-1,6-hexanediylbis[3-(1,1-dimethylethyl)-4-hydroxy-5-methyl benzenepropanamide; 3-(1,1-dimethylethyl)-4-hydroxy-5-methyl benzenepropanoic acid, 1,1′-[2,4,8, 10-tetraoxaspiro[5.5]undecane-3,9-diylbis(2,2-dimethyl-2,1-ethanediyl)] ester; 3-(1,1-dimethylethyl)-4-hydroxy-5-methylbenzenepropanoic acid, 1,1′-[1,2-ethanediylbis(oxy-2,1-ethanediyl)] ester; 3-(1,1-dimethylethyl)-4-hydroxy-5-methylbenzenepropanoic acid, 1,1′-[2,4,8,10-tetraoxaspiro[5.5]undecane-3,9-diylbis(2,2-dimethyl-2,1-ethanediyl)] ester; and mixtures thereof.

Bis-phenols suitable for use herein may include, but are not limited to, those selected from 4,4′-methylenebis[2,6-dimethylphenol]; 4,4′-(1-methylethylidene)bis[2,6-dimethylphenol]; 4,4′-methylenebis[2-(1,1-dimethylethyl)-6-methylphenol]; 4,4′-methylenebis[2,6-bis(1,1-dimethylethyl)pheno]; 4,4 ′-(1-methylethylidene)bis[2,6-bis(1,1-dimethylethyl)phenol]; 4,4′-Methylenebis[6-(1,1-dimethylethyl)-2,3-dimethylphenol]; 2-[(2-Hydroxy-3,5-dimethylphenyl)methyl]-4,6-dimethylphenol; 2,2 ′-Methylenebis[4,6-bis(1-methylethyl)phenol]; 4-(1, 1-Dimethylethyl)-2-[[5-(1,1-dimethylethyl)-2-hydroxy-3-methylphenyl]methyl]-6-methylphenol]; 2,2′-Methylenebis[6-(1,1-dimethylethyl)-4-methylphenol]; 2,2′-Methylenebis[6-(1,1-dimethylethyl)-4-ethylphenol]; 2,2′-Methylenebis[6-(1,1-dimethylethyl)-4-(1-methylethyl)phenol]; 2,2′-Methylenebis[6-(1,1-dimethylethyl)-4-(1-methylpropyl)phenol]; 2,2′-Methylenebis[4-(1,1-dimethylethyl)-6-(1-methylpropyl)phenol]; 2,2′-Ethylidenebis[6-(1,1-dimethylethyl)-4-(1-methylpropyl)phenol]; 2,2′-Methylenebis[4,6-bis(1,1-dimethylethyl)phenol]; 2,2′-Ethylidenebis[4,6-bis(1,1-dimethylethyl)phenol]; 2,2′-Methylenebis[6-(1,1-dimethylethyl)-3,4-dimethylphenol]; 2,2′-Methylenebis[4-(1,1-dimethylethyl)-3,6-dimethylphenol]; 2,2′-Methylenebis[6-(1,1-dimethylethyl)-4-ethyl-3-methylphenol]; 2,2′-Methylenebis[4,6-bis(1,1-dimethylethyl)-3-methylphenol]; and mixtures thereof.

Optionally, the phenol can be C₁-C₈ linear or branched alkyl esters of 3,5-bis(1,1-dimethylethyl)-4-hydroxy-benzenepropanoic acid. An optional example of a C₁-C₈ linear or branched alkyl ester of 3,5-bis(1,1-dimethylethyl)-4-hydroxy-benzenepropanoic acid includes 3,5-bis(1,1-dimethylethyl)-4-hydroxy-benzenepropanoic acid, methyl ester (commercially available under the tradename RALOX 35 from Raschig USA, Arlington, Texas, United States). Optionally, the phenol can be a mono- or bis-ester of 3-(1,1-dimethylethyl)-4-hydroxy-5-methyl benzenepropanoic acid. An optional example of a mono- or bis-ester of 3-(1,1-dimethylethyl)-4-hydroxy-5-methyl benzenepropanoic acid includes 3-(1,1-dimethylethyl)-4-hydroxy-5-methyl benzenepropanoic acid, 1,1′-[1,2-ethanediylbis(oxy-2,1-ethanediyl)] ester (commercially available under the tradename IRGANOX 245 from BASF, Ludwigshafen, Germany). Optionally the bis-phenol can be a 2,2′-methylenebis-phenol. An optional example of a 2,2′-methylenebis-phenol includes 2,2′-methylenebis[6-(1,1-dimethylethyl)-4-methylphenol (commercially available under the tradename IRGANOX 2246 from BASF, Ludwigshafen, Germany). Additional phenolic antioxidants may be employed. Examples of suitable phenolic antioxidants may be selected from a-, b-, g-, and d-tocopherol; a-, b-, g-, and d-tocotrienol; 2,2,4-trimethyl-1,2-dihydroquinoline; tert-butyl hydroxyanisole; 6-hydroxy-2,5,7,8-tetramethylchroman-2-carboxylic acid; and mixtures thereof.

An example of an aryl amine useful as an antioxidant in particles of the present disclosure is ethoxyquin (e.g., 1,2-dihydro-6-ethoxy-2,2,4-trimethylquinoline, commercially available under the tradename RALUQUIN™, from Raschig USA, Arlington, Texas, United States). The aryl amine may be a diarylamine. Diarylamines that are useful in the particles disclosed herein can be represented by the general formula

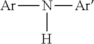

wherein Ar and Ar′ are each independently selected from aromatic aryl radicals and heteroaromatic aryl radicals, wherein at least one aryl radical is substituted. Suitable diarylamines may include, but are not limited to, 4-(1,1,3,3-tetramethylbutyl)-N-[4-(1,1,3,3-tetramethylbutyl)phenyl]-benzenamine (commercially available under the tradename IRGANOX 5057 from BASF, Ludwigshafen, Germany) and 4-(1-methyl-1-phenylethyl)-N-[4-(1-methyl-1-phenylethyl)phenyl]-benzenamine (commercially available under the tradename NAUGARD 445 from Addivant, Danbury, Connecticut, United States).

There is the possibility that some of the antioxidant that has an ester group may hydrolyze, transesterify, or amidate when the particles are made by melt processing due to the elevated temperature. That may lead to low levels of impurities such as propanoic acid antioxidant, a PEGylated propanoate, or formation of an amide form from, for example, an amine present for delivering the perfume. While antioxidants are typically commercially available in high purity, they nonetheless comprise some very low level impurities that may arise from their synthesis or perhaps from degradation on storage. Some of these impurities may also serve as antioxidants. Removal of all such impurities is impractical on an industrial scale and typically there is no need to remove such impurities and they are carried over into the final product. Further, the oxidation products resulting from the intended function of the antioxidant are expected to be found in the particles.

The melt point of the antioxidant can be less than the boiling point of the perfume, if a perfume is present. That can limit loss of perfume during the manufacturing process. The melt point of the antioxidant can be less than 68 C. Such antioxidants can be practical for melt processing since a melt of the carrier system and the antioxidant can be processed at a temperature that is below the boiling point of the perfume, if provided. In some aspects, antioxidants with a melting point below that of the carrier system may be practical, as this enables the particles to be made at the lowest possible temperature, thereby minimizing the loss of volatile perfumes during manufacture.

### Diphenyl Ether-Based Anti-Microbial Agent

The plurality of particles can comprise a diphenyl ether-based anti-microbial agent as the fabric care benefit agent. The anti-microbial agent may be present from 0.01% to 3%, optionally from 0.02% to 2%, more optionally from 0.05% to 1%, optionally from 0.1% to 0.5% by weight.

Optionally, the anti-microbial agent can be a hydroxyl diphenyl ether. The anti-microbial agent herein can be either halogenated or non-halogenated, but optionally is halogenated. In one embodiment, the anti-microbial agent is a hydroxyl diphenyl ether of formula (I):

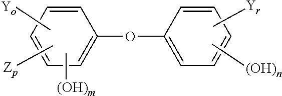

wherein:
each Y is independently selected from chlorine, bromine, or fluorine, optionally is chlorine or bromine, optionally is chlorine,
each Z is independently selected from SO₂H, NO₂, or C₁-C₄ alkyl,
r is 0, 1, 2, or 3, optionally is 1 or 2,
o is 0, 1, 2, or 3, optionally is 0, 1 or 2,
p is 0, 1, or 2, optionally is 0,
m is 1 or 2, optionally is 1, and
n is 0 or 1, optionally is 0.

In the above definition for formula (I), 0 means nil. For example, when p is 0, then there is no Z in formula (I). Each Y and each Z could be the same or different. In one embodiment, o is 1, r is 2, and Y is chlorine or bromine. This embodiment could be: one chlorine atom bonds to a benzene ring while the bromine atom and the other chlorine atom bond to the other benzene ring; or the bromine atom bonds to a benzene ring while the two chlorine atoms bond to the other benzene ring.

Optionally, the anti-microbial agent is selected from 4-4′-dichloro-2-hydroxy diphenyl ether (“Diclosan”), 2,4,4,-trichloro-2′-hydroxy diphenyl ether (“Triclosan”), and a combination thereof. Optionally, the anti-microbial agent is 4-4′-dichloro-2-hydroxy diphenyl ether, commercially available from BASF, under the trademark name TINOSAN HP100.

### Starch

The plurality of particles can comprise starch and or modified starch as the fabric care benefit agent. The plurality of particles can comprise from about 0.1% to about 50% by weight of the plurality of particles of starch granules. Including starch granules in the particles can provide for improved perfume stability from the time of manufacture to the time of purchase as compared to particles that do not include starch granules. The plurality of particles can comprise from about 0.1% to about 40% by weight of the plurality of particles of starch granules. The plurality of particles can comprise from about 0.1% to about 30% by weight of the plurality of particles of starch granules. The starch granules can be MELOJEL corn starch from Ingredion. The starch granules can be wheat, rice, potato, tapioca. The starch granules can be a polysaccharide material such as cellulose, xanthan gum, or gum arabic.

The starch granules can have a dextrose equivalent from 0 to about 40. Dextrose equivalent is a characterization of the degree of hydrolyzation of the starch into simpler carbohydrates. The extent of conversion of starch is quantified by dextrose equivalent, which is roughly the fraction of glucosidic bonds that have been broken, or the degree of starch polymer hydrolysis, which is controlled by the hydrolysis reaction. It is a measure of reducing power, in the form of reducing sugars, compared to a dextrose standard of 100. The higher the dextrose equivalent, the greater the extent of starch hydrolysis. Fully hydrolyzed starch, or dextrose, has a dextrose equivalent of 100. Unmodified starch has a dextrose equivalent of 0. Maltodextrins are made by partial hydrolysis of corn starch with suitable acids and/or enzymes and have a dextrose equivalent of less than 20. Corn syrup solids and liquid corn syrups have a dextrose equivalent of greater than 20. The starch granules can have a dextrose equivalent from 0 to about 25. The dextrose equivalent of the starch granules is measured using the method of ISO 5377:1981.

The plurality of particles can comprise from about 0.1% to about 50% by weight of the particles of modified starch. Modified starch can be prepared by physically, enzymatically, or chemically treating native starch to change its properties. Starch and or modified starch may be provided in the plurality of particles to improve the color stability of the particles.

### Enzyme

The plurality of particles can comprise enzyme as the fabric care benefit agent. The enzyme in the plurality of particles can be provided at a level of 0.0001% to about 5% by weight of the plurality of particles an enzyme selected from the group consisting of care enzyme, nuclease, and combinations thereof. The enzyme in the plurality of particles can be provided at a level of 0.001% to about 5% by weight of the plurality of particles an enzyme selected from the group consisting of care enzyme, nuclease, and combinations thereof. The enzyme in the particles disclosed herein can be an enzyme selected from the group consisting amylase, lipase, protease, cellulase, xyloglucanase, pectate lyase, peroxidases, mannanase, cutinases, P-nitrobenzylesterases, nucleases, and mixtures thereof. The enzyme in the plurality of particles can be provided at a level of 0.0001% to about 5% by weight of the plurality of particles. The enzyme in the particles can be provided at a level of 0.001% to about 5% by weight of the plurality of particles. These enzymes when used in laundering processes, can provide for one or more of stain removal, fabric rejuvenation, and malodor remediation. The enzyme can be nuclease, which can reduce malodor associated with fabrics.

The enzyme can be in liquid, solid, or other form. The enzyme can be substantially homogeneously mixed with the carrier system. Substantially homogeneously mixed components need not be perfectly homogeneous. The degree of homogeneity can be that which can be provided by mixing processes used by those skilled in the art in commercial applications to make particles.

The care enzyme can be a cellulase. The care enzyme can be an enzyme of the glycoside hydrolase family. Glycoside Hydrolase Family means any Glycoside Hydrolase Family (designated by number) of the Glycoside Hydrolase Family Classification system, based on amino acid similarities, being part of the Carbohydrate-Active Enzymes database (CAZy) developed by the Glycogenomics group at Architecture et Fonction des Macromolecules Biologiques, Unite Mixte de Recherches UMR^{6098,} CNRS, Universite de Provence Universite de la Mediterranee.

The enzyme can be an enzyme of the glycosyl hydrolase family 45. Glycoside Hydrolase Family 45 includes the inverting enzymes of endoglucanase (EC 3.2.1 .4).

The enzyme can be cellulase that is alkaline or neutral cellulase having a color care benefits. The care enzymes, as disclosed herein, can have a molecular weight of from about 17 kDa to about 30 kDa. The enzyme can be, for example, the endoglucanases sold under the tradename Biotouch(R) NCD, DCC and DCL (AB Enzymes, Darmstadt, Germany). Other preferred commercially available cellulases include CELLUZYME, CAREZYME, and RENOZYME (Novozymes A S), CLAZINASE, PURADAX HA, PURADAX(R) EG-L, and PURADAx(R) HA (Genencor International Inc.), and KAC-500(B), KAC(R)-500(B) (Kao Corporation).

Other enzymes that can provide for an anti-pilling appearance benefit include cutinase (cutin hydrolases—EC 3.1.1.74) and P-nitrobenzylesterases (carboxyl esterases—EC 3.1.1.1). Examples of cutinase can be found in EP2767582A1. Examples of P-nitrobenzylesterases can be found in WO2007017181 and WO2015135757.

The enzyme, if provided, can be selected from the group consisting of glycoside hydrolase family 45, cutinase, and P-nitrobenzylesterase, and mixtures thereof. The particle can comprise from about 0.5% to less than 3% by weight of the particles of an enzyme selected from the group of amylase, lipase, protease, cellulase, xyloglucanase, pectate lyase, peroxidases, mannanase, cutinases, P-nitrobenzylesterases, nucleases, and mixtures thereof. The nuclease enzyme is an enzyme capable of cleaving the phosphodiester bonds between the nucleotide sub-units of nucleic acids. The nuclease enzyme herein can be a deoxyribonuclease or ribonuclease enzyme or a functional fragment thereof. By functional fragment or part is meant the portion of the nuclease enzyme that catalyzes the cleavage of phosphodiester linkages in the DNA backbone and so is a region of said nuclease protein that retains catalytic activity. Thus, it includes truncated, but functional versions, of the enzyme and/or variants and/or derivatives and/or homologues whose functionality is maintained.

The nuclease enzyme can be a deoxyribonuclease. The nuclease enzyme can be a deoxyribonuclease selected from the group consisting of any of the classes E.C. 3.1.21.x, where x=1, 2, 3, 4, 5, 6, 7, 8 or 9, E.C. 3.1.22.y where y=1, 2, 4 or 5, E.C. 3.1.30.z where z=1 or 2, E.C. 3.1.31.1 and mixtures thereof.

Nuclease enzymes from class E.C. 3.1.21.x and E.C. 3.1.21.x where x=1 can be practical. Nucleases in class E.C. 3.1.22.y cleave at the 5′ hydroxyl to liberate 3′ phosphomonoesters. Enzymes in class E.C. 3.1.30.z can be practical as they act on both DNA and RNA and liberate 5′-phosphomonoesters. Suitable examples from class E.C. 3.1.31.2 are described in US2012/0135498A. Such enzymes are commercially available as DENARASE® enzyme from c-LECTA. Nuclease enzymes from class E.C. 3.1.31.1 produce 3′phosphomonoesters.

The nuclease enzyme can comprise a microbial enzyme. The nuclease enzyme may be fungal or bacterial in origin. Bacterial nucleases can be practical. Fungal nucleases may practical as well.

The microbial nuclease is obtainable from Bacillus, such as a Bacillus licheniformis or Bacillus subtilis bacterial nucleases. A practical nuclease is obtainable from Bacillus licheniformis, optionally from strain EI-34-6. A practical deoxyribonuclease is a variant of Bacillus licheniformis, from strain EI-34-6 nucB deoxyribonuclease.

A fungal nuclease is obtainable from Aspergillus, for example Aspergillus oryzae. A preferred nuclease is obtainable from Aspergillus oryzae.

Another suitable fungal nuclease is obtainable from Trichoderma, for example Trichoderma harzianum. A practical nuclease can be obtained from Trichoderma harzianum.

Other fungal nucleases include Aspergillus oryzae RIB40, Aspergillus oryzae 3.042, Aspergillus flavus NRRL3357, Aspergillus parasiticus SU-1, Aspergillus nomius NRRL13137, Trichoderma reesei QM6a, Trichoderma virens Gv29-8, Oidiodendron maius Zn, Metarhizium guizhouense ARSEF 977, Metarhizium majus ARSEF 297, Metarhizium robertsii ARSEF 23, Metarhizium acridum CQMa 102, Metarhizium brunneum ARSEF 3297, Metarhizium anisopliae, Colletotrichum fioriniae PJ7, Colletotrichum sublineola, Trichoderma atroviride IMI 206040, Tolypocladium ophioglossoides CBS 100239, Beauveria bassiana ARSEF 2860, Colletotrichum higginsianum, Hirsutella minnesotensis 3608, Scedosporium apiospermum, Phaeomoniella chlamydospora, Fusarium verticillioides 7600, Fusarium oxysporum f. sp. cubense race 4, Colletotrichum graminicola M1.001, Fusarium oxysporum FOSC 3-a, Fusarium avenaceum, Fusarium langsethiae, Grosmannia clavigera kw1407, Claviceps purpurea 20.1, Verticillium longisporum, Fusarium oxysporum f. sp. cubense race 1, Magnaporthe oryzae 70-15, Beauveria bassiana D1-5, Fusarium pseudograminearum CS3096, Neonectria ditissima, Magnaporthiopsis pode ATCC 64411, Cordyceps militaris CM01, Marssonina brunnea f. sp. ‘multigermtubi’ MB_m1, Diaporthe ampelina, Metarhizium album ARSEF 1941, Colletotrichum gloeosporioides Nara gc5, Madurella mycetomatis, Metarhizium brunneum ARSEF 3297, Verticillium alfalfae VaMs.102, Gaeumannomyces graminis var. tritici R³-111a-1, Nectria haematococca mpVI 77-13-4, Verticillium longisporum, Verticillium dahliae VdLs.17, Torrubiella hemipterigena, Verticillium longisporum, Verticillium dahliae VdLs.17, Botrytis cinerea B05.10, Chaetomium globosum CBS 148.51, Metarhizium anisopliae, Stemphylium lycopersici, Sclerotinia borealis F-4157, Metarhizium robertsii ARSEF 23, Myceliophthora thermophila ATCC 42464, Phaeosphaeria nodorum SN15, Phialophora attae, Ustilaginoidea virens, Diplodia seriata, Ophiostoma piceae UAMH 11346, Pseudogymnoascus pannorum VKM F-4515 (FW-2607), Bipolaris oryzae ATCC 44560, Metarhizium guizhouense ARSEF 977, Chaetomium thermophilum var. thermophilum DSM 1495, Pestalotiopsis fici W106-1, Bipolaris zeicola 26-R-13, Setosphaeria turcica Et28A, Arthroderma otae CBS 113480 and Pyrenophora tritici-repentis Pt-1C-BFP.

The nuclease can be an isolated nuclease. The nuclease enzyme can be present in a the laundering aqueous solution in an amount of from about 0.01ppm to about 1000 ppm of the nuclease enzyme, or from about 0.05 or from about 0.1ppm to about 750 or about 500ppm. The nucleases may also give rise to biofilm-disrupting effects.

The composition can additionally comprise a β-N-acetylglucosaminidase enzyme from E.C. 3.2.1.52.

### Silicone

The plurality of particles can comprise about 0.1% to about 60% by weight of the plurality of particles silicone as the fabric care benefit agent. The plurality of particles can comprise about 3% to about 50% by weight of the plurality of particles silicone. The plurality of particles can comprise about 10% to about 40% by weight of the plurality of particles silicone. The plurality of particles can comprise about 20% to about 35% by weight of the plurality of particles silicone. The plurality of particles can comprise about 28% to about 32% by weight of the plurality of particles silicone.

Suitable silicones comprise Si-O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C.

Suitable organosilicones may be linear, branched or cross-linked. In one aspect, the organosilicones may comprise silicone resins. Silicone resins are highly cross-linked polymeric siloxane systems. The cross-linking is introduced through the incorporation of trifunctional and tetrafunctional silanes with monofunctional or difunctional, or both, silanes during manufacture of the silicone resin. As used herein, the nomenclature SiO“n”/2 represents the ratio of oxygen and silicon atoms. For example, SiO_{1/2} means that one oxygen is shared between two Si atoms. Likewise SiO_{2/2} means that two oxygen atoms are shared between two Si atoms and SiO_{3/2} means that three oxygen atoms are shared are shared between two Si atoms.

Silicone materials and silicone resins in particular, can conveniently be identified according to a shorthand nomenclature system known to those of ordinary skill in the art as “MDTQ” nomen-clature. Under this system, the silicone is described according to presence of various siloxane monomer units which make up the silicone. Briefly, the symbol M denotes the monofunctional unit (CH₃)₃SiO_{0.5}; D denotes the difunctional unit (CH₃)₂SiO; T denotes the trifunctional unit (CH₃)SiO_{1.5}; and Q denotes the quadra- or tetra-functional unit SiO₂. Primes of the unit symbols (e.g. M′, D′, T′, and Q′) denote substituents other than methyl, and must be specifically defined for each occurrence.

Other modified silicones or silicone copolymers are also useful herein. Examples of these include silicone-based quaternary ammonium compounds (Kennan quats) disclosed in U.S. Pat. Nos. 6,607,717 and 6,482,969; end-terminal quaternary siloxanes; silicone aminopolyalkyleneoxide block copolymers disclosed in U.S. Pat. Nos.5,807,956 and 5,981,681; hydrophilic silicone emulsions disclosed in U.S. Pat. No. 6,207,782; and polymers made up of one or more crosslinked rake or comb silicone copolymer segments disclosed in U.S. Pat. No7,465,439. Additional modified silicones or silicone copolymers useful herein are described in US Patent Publications 2007/0286837A1 and 2005/0048549A1.

In alternative embodiments, the above-noted silicone-based quaternary ammonium compounds may be combined with the silicone polymers described in U.S. Pat. Nos. 7,041,767 and 7,217,777 and US Patent Publication 2007/0041929A1.

In one aspect, the organosilicone may comprise a non-functionalized siloxane polymer that may have the following formula, and may comprise polyalkyl and/or phenyl silicone fluids, resins and/or gums.

[R₁R₂R₃SiO_{1/2}]ₙ[R₄R₄SiO_{2/2}]ₘ[R₄SiO_{3/2}]ⱼ

wherein:
i) each R₁, R₂, R₃ and R₄ may be independently selected from the group consisting of H, —OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy, moieties;
ii) n may be an integer from about 2 to about 10, or from about 2 to about 6; or 2; such that n=j±2;
iii) m may be an integer from about 5 to about 8,000, from about 7 to about 8,000 or from about 15 to about 4,000;
iv) j may be an integer from 0 to about 10, or from 0 to about 4, or 0.

In one aspect, R₂, R₃ and R₄ may comprise methyl, ethyl, propyl, C₄-C₂₀ alkyl, and/or C₆-C₂₀ aryl moieties. In one aspect, each of R₂, R₃ and R₄ may be methyl. Each R₁ moiety blocking the ends of the silicone chain may comprise a moiety selected from the group consisting of hydrogen, methyl, methoxy, ethoxy, hydroxy, propoxy, and/or aryloxy.

In one aspect, the organosilicone may be polydimethylsiloxane, dimethicone, dimethiconol, dimethicone crosspolymer, phenyl trimethicone, alkyl dimethicone, lauryl dimethicone, stearyl dimethicone and phenyl dimethicone. Examples include those available under the names DC 200 Fluid, DC 1664, DC 349, DC 346G available from Dow Corning Corporation, Midland, MI, and those available under the trade names SF1202, SF1204, SF96, and VISCASIL available from Momentive Silicones, Waterford, NY.

In one aspect, the organosilicone may comprise a cyclic silicone. The cyclic silicone may comprise a cyclomethicone of the formula [(CH₃)₂SiO]ₙ where n is an integer that may range from about 3 to about 7, or from about 5 to about 6.

In one aspect, the organosilicone may comprise a functionalized siloxane polymer. Functionalized siloxane polymers may comprise one or more functional moieties selected from the group consisting of amino, amido, alkoxy, hydroxy, polyether, carboxy, hydride, mercapto, sulfate phosphate, and/or quaternary ammonium moieties. These moieties may be attached directly to the siloxane backbone through a bivalent alkylene radical, (i.e., “pendant”) or may be part of the backbone. Suitable functionalized siloxane polymers include materials selected from the group consisting of aminosilicones, amidosilicones, silicone polyethers, silicone-urethane polymers, quaternary ABn silicones, amino ABn silicones, and combinations thereof.

In one aspect, the functionalized siloxane polymer may comprise a silicone polyether, also referred to as “dimethicone copolyol.” In general, silicone polyethers comprise a polydimethylsiloxane backbone with one or more polyoxyalkylene chains. The polyoxyalkylene moieties may be incorporated in the polymer as pendent chains or as terminal blocks. Such silicones are described in US Patent Publication 2005/0098759, and U.S. Pat. Nos. 4,818,421 and 3,299,112. Exemplary commercially available silicone polyethers include DC 190, DC 193, FF400, all available from Dow Corning Corporation, and various SILWET surfactants available from Momentive Silicones.

In another aspect, the functionalized siloxane polymer may comprise an aminosilicone. Suitable aminosilicones are described in U.S. Pat. Nos. 7,335,630 B2, 4,911,852, and US Patent Publication 2005/0170994A1. In one aspect the aminosilicone may be that described in U.S. Provisional Patent Application 61/221,632. In another aspect, the aminosilicone may comprise the structure of the following formula:

[R₁R₂R₃SiO_{1/2}]ₙ[R₄Si(X—Z)O_{2/2}]ₖ[R₄R₄SiO_{2/2}]ₘ[R₄SiO_{3/2}]ⱼ
wherein:
i. R^{1,} R², R³ and R⁴ may each be independently selected from H, OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy;
ii. Each X may be independently selected from a divalent alkylene radical comprising 2-12 carbon atoms, —(CH₂)s- wherein s may be an integer from about 2 to about 10; —CH₂—CH(OH)—CH₂—; and/or

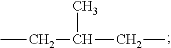

iii. Each Z may be independently selected from —N(R⁵)₂; —

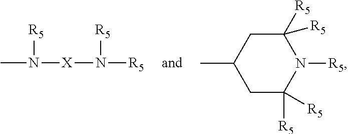

wherein each R₅may be selected independently selected from H, C₁-C₂₀ alkyl; and A⁻ may be a compatible anion. In one aspect, A⁻ may be a halide;
iv. k may be an integer from about 3 to about 20, from about 5 to about 18 more or even from about 5 to about 10;
v. m may be an integer from about 100 to about 2,000, or from about 150 to about 1,000;
vi. n may be an integer from about 2 to about 10, or about 2 to about 6, or 2, such that n=j+2; and
vii. j may be an integer from 0 to about 10, or from 0 to about 4, or 0.

In one aspect, R¹ may comprise —OH. In this aspect, the organosilicone is amidomethicone. Exemplary commercially available aminosilicones include DC 8822, 2-8177, and DC-949, available from Dow Corning Corporation, and KF-873, available from Shin-Etsu Silicones, Akron, OH.

In one aspect the silicone may be chosen from a random or blocky organosilicone polymer having the following formula:

[R₁R²R³SiO_{1/2}]₍ⱼ₊₂₎[(R⁴Si(X—Z)O_{2/2}]ₖ[R⁴R⁴SiO_{2/2}]m[R⁴SiO_{3/2}]ⱼ
wherein:
   j is an integer from 0 to about 98; in one aspect j is an integer from 0 to about 48; in one aspect, j is 0;
   k is an integer from 0 to about 200, in one aspect k is an integer from 0 to about 50; when k=0, at least one of R^{1,} R² or R³ is —X—Z;
   m is an integer from 4 to about 5,000; in one aspect m is an integer from about 10 to about 4,000; in another aspect m is an integer from about 50 to about 2,000;
   R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X—Z;
   each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
   each X in said alkyl siloxane polymer comprises a substituted or unsubstituted divalent alkylene radical comprising 2-12 carbon atoms, in one aspect each divalent alkylene radical is independently selected from the group consisting of —(CH₂)s- wherein s is an integer from about 2 to about 8, from about 2 to about 4; in one aspect, each X in said alkyl siloxane polymer comprises a substituted divalent alkylene radical selected from the group consisting of: —CH₂—CH(OH)—CH₂ —; —CH₂—CH₂—CH(OH)—; and

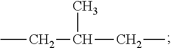

each Z is selected independently from the group consisting of

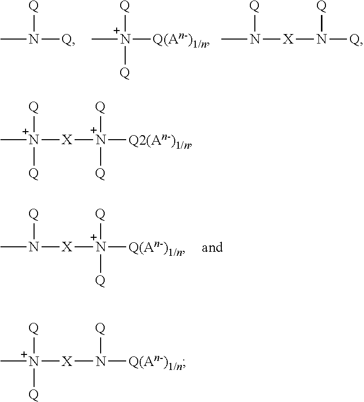

with the proviso that when Z is a quat, Q cannot be an amide, imine, or urea moiety; for Z Aⁿ⁻ is a suitable charge balancing anion. In one aspect Aⁿ⁻ is selected from the group consisting of Cl⁻, Br⁻, I⁻, methylsulfate, toluene sulfonate, carboxylate and phosphate ; and at least one Q in said organosilicone is independently selected from —CH₂—CH(OH)—CH₂—R₅;

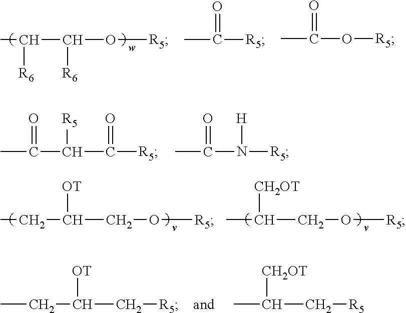

each additional Q in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—CH(OH)—CH₂—R₅;

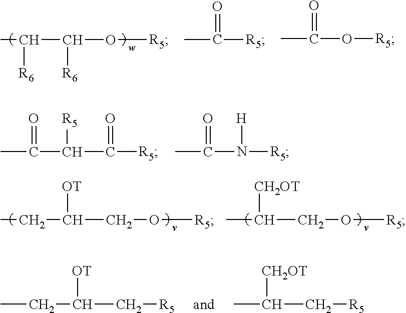

wherein each R₅ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR⁶—CHR⁶—O—)_{w}-L and a siloxyl residue;
each R⁶ is independently selected from H, C₁-C₁₈ alkyl
each L is independently selected from —C(O)—R⁷ or R⁷;
w is an integer from 0 to about 500, in one aspect w is an integer from about 1 to about 200; in one aspect w is an integer from about 1 to about 50;
each R⁷ is selected independently from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl; C₆-C₃₂ substituted alkylaryl and a siloxyl residue;
each T is independently selected from H, and

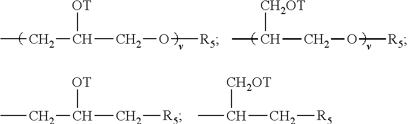

and
wherein each v in said organosilicone is an integer from 1 to about 10, in one aspect, v is an integer from 1 to about 5 and the sum of all v indices in each Q in the said organosilicone is an integer from 1 to about 30 or from 1 to about 20 or even from 1 to about 10.

In one aspect, the organosilicone may comprise amine ABn silicones and quat ABn silicones. Such organosilicones are generally produced by reacting a diamine with an epoxide. These are described, for example, in U.S. Pat. Nos. 6,903,061, 5,981,681, 5,807,956, 6,903,061 and 7,273,837. These are commercially available under the trade names MAGNASOFT, PRIME, MAGNASOFT JSS, SILSOFT, and A-858, all from Momentive Silicones.

In another aspect, the functionalized siloxane polymer may comprise silicone-urethanes, such as those described in US Provisional Patent Application 61/170,150. These are commercially available from Wacker Silicones under the trade name SLM-21200.

When a sample of organosilicone is analyzed, it is recognized by the skilled artisan that such sample may have, on average, the non-integer indices for Formula (I) and (II) above, but that such average indices values will be within the ranges of the indices for Formula (I) and (II) above.

The silicone can be an aminosilicone having the formula:

[R₁R₂R³SiO_{1/2}]₍ⱼ₊₂₎[(R₄Si(X—Z)O_{2/2}]ₖ[R₄R₄SiO_{2/2}]ₘ[R₄SiO_{3/2}]ⱼ
wherein:
   j is 0;
   k is an integer from 1 to about 10;
   m is an integer from 150 to about 1000; in one aspect m is an integer from about 325 to about 750 ; in another aspect m is an integer from about 400 to about 600;
   each R₁, R₂ and R³ is C₁-C₃₂ alkoxy and or C₁-C₃₂ alkyl;
   each R₄ is C₁-C₃₂ alkyl
   each X is selected from the group consisting of —(CH₂)ₛ— wherein s is an integer from about 2 to about 8, from about 2 to about 4;
   each Z is selected independently from the group consisting of

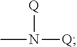

each Q in said silicone is selected from the group comprising of H.

The silicone can be an aminosilicone having the formula:

[R₁R₂R³SiO_{1/2}]₍ⱼ₊₂₎[(R₄Si(X—Z)O_{2/2}]ₖ[R₄R₄SiO_{2/2}]ₘ[R₄SiO_{3/2}]ⱼ
wherein:
   j is 0;
   k is an integer from 1 to about 10;
   m is an integer from 150 to about 1000; in one aspect m is an integer from about 325 to about 750 ; in another aspect m is an integer from about 400 to about 600;
   each R₁, R₂ and R³ is C₁-C₃₂ alkoxy and or C₁-C₃₂ alkyl;
   each R₄ is C₁-C₃₂ alkyl
   each X is selected from the group consisting of —(CH₂)ₛ— wherein s is an integer from about 2 to about 8, from about 2 to about 4;
   each Z is selected independently from the group consisting of

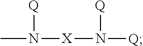

each Q in said silicone is selected from the group comprising of H.

The silicone can be an aminosilicone having the formula:

[R₁R₂R³SiO_{1/2}]₍ⱼ₊₂₎[(R₄Si(X—Z)O_{2/2}]ₖ[R₄R₄SiO_{2/2}]ₘ[R₄SiO_{3/2}]ⱼ
wherein:
   j is 0;
   k is an integer from 1 to about 5;
   m is an integer from 250 to about 750; in one aspect m is an integer from about 325 to about 675; in another aspect m is an integer from about 400 to about 600;
   each R₁, R₂ and R³ is C₁-C₃₂ alkoxy and or C₁-C₃₂ alkyl;
   each R₄ is C₁-C₃₂ alkyl
   each X is selected from the group consisting of —(CH₂)ₛ— wherein s is an integer from about 2 to about 8, from about 2 to about 4;
   each Z is selected independently from the group consisting of

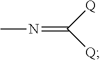

each additional Q in said silicone is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₅-C₃₂ substituted alkylaryl; with the proviso that both Q cannot be H atoms.

The silicone can be mixed with the carrier system. The silicone can be dispersed in the carrier system. The silicone can be dispersed in the carrier system as droplets. The mean particle size of the silicone disposed in the carrier system material can be from about 2 μm to about 2000 μm.

The silicone can be dimethyl, methyl (3-aminopropyl) siloxane, trimethylsiloxy-terminated, CAS-No. 99363-37-8, available from Dow Corning as Dow Corning as DOW CORNING(R) XX-8766 AMINO POLYMER, product code 000000000004121334. An exemplary silicone can be the following formula.

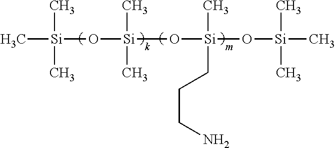

The silicone can be an aminosilicone having the following formula.

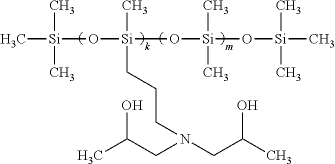

The silicone can be an anionic silicone. Examples of anionic silicones are silicones that incorporate carboxylic, sulphate, sulphonic, phosphate and/or phosphonate functionality. The anionic silicone may be in the form of the acid or the anion. For example for the carboxyl functionalised silicone, it may be present as a carboxylic acid or carboxylate anion. The anionic silicone can have a molecular weight of from 1,000 to 100,000, or from 2,000 to 50,000, or even more from 5,000 to 50,000, or even from 10,000 to 50,000.

### Organic Conditioning Oils

The plurality of particles may comprise at least one organic conditioning oil as the fabric care benefit agent, either alone or in combination with other fabric care benefit agents, such as the silicones. Suitable organic conditioning oils include hydrocarbon oils, polyolefins, fatty esters, methathesized unsaturated polyol esters, or silane-modified oils. Organic conditioning oils for use in the particles disclosed herein can also include liquid polyolefins, liquid poly-α-olefins, hydrogenated liquid poly-α-olefins, and the like. Polyolefins for use herein are prepared by polymerization of C₄ to about C₁₄ olefenic monomers.

Non-limiting examples of olefenic monomers for use in preparing the polyolefin liquids herein include ethylene, propylene, butene (including isobutene), pentene, hexene, octene, decene, dodecene, tetradecene, branched chain isomers such as 4-methyl-1-pentene, and mixtures thereof. Also suitable for preparing the polyolefin liquids are olefin-containing refinery feedstocks or effluents. Hydrogenated α-olefin monomers include, but are not limited to: 1-hexene to 1-hexadecenes, 1-octene to 1-tetradecene, and mixtures thereof.

### Hydrocarbon Oils

The plurality of particles may comprise hydrocarbon oils as the fabric care benefit agent. Suitable organic conditioning oils for use as fabric care benefit agent in the compositions of the particles disclosed herein include, but are not limited to, hydrocarbon oils having at least about 10 carbon atoms, such as cyclic hydrocarbons, straight chain aliphatic hydrocarbons (saturated or unsaturated), and branched chain aliphatic hydrocarbons (saturated or unsaturated), including polymers and mixtures thereof. Straight chain hydrocarbon oils optionally are from about C₁₂ to about C₂₂.

Specific non-limiting examples of these hydrocarbon oils include paraffin oil, mineral oil, saturated and unsaturated dodecane, saturated and unsaturated tridecane, saturated and unsaturated tetradecane, saturated and unsaturated pentadecane, saturated and unsaturated hexadecane, polybutene, polyisobutylene, polydecene, and mixtures thereof. Branched-chain isomers of these compounds, as well as of higher chain length hydrocarbons, can also be used, examples of which include highly branched, saturated or unsaturated, alkanes such as the permethyl-substituted isomers, e.g., the permethyl-substituted isomers of hexadecane and eicosane, such as 2, 2, 4, 4, 6, 6, 8, 8-dimethyl-10-methylundecane and 2, 2, 4, 4, 6, 6-dimethyl-8-methylnonane, available from Permethyl Corporation. Hydrocarbon polymers such as polybutene and polydecene. A preferred hydrocarbon polymer is polybutene, such as the copolymer of isobutylene and butene. A commercially available material of this type is L-14 polybutene from Amoco Chemical Corporation. Another preferred hydrocarbon polymer is polyisobutylene, a non-limiting example being polyisobutylene having a number average molecular weight of 1,000 and commercially available from EVONIK Industries AG under the trade name REWOPAL PIB 1000.

### Fatty Esters

The fabric care benefit agent can be a fatty ester. Suitable fatty esters include, but are not limited to, fatty esters having at least 10 carbon atoms. These fatty esters include esters with hydrocarbyl chains derived from fatty acids or alcohols (e.g. mono-esters, polyhydric alcohol esters, and di- and tri-carboxylic acid esters). The hydrocarbyl radicals of the fatty esters hereof may include or have covalently bonded thereto other compatible functionalities, such as amides and alkoxy moieties (e.g., ethoxy or ether linkages, etc.).

Specific examples of fatty esters include, but are not limited to: isopropyl isostearate, hexyl laurate, isohexyl laurate, isohexyl palmitate, isopropyl palmitate, decyl oleate, isodecyl oleate, hexadecyl stearate, decyl stearate, isopropyl isostearate, dihexyldecyl adipate, lauryl lactate, myristyl lactate, cetyl lactate, oleyl stearate, oleyl oleate, oleyl myristate, lauryl acetate, cetyl propionate, and oleyl adipate.

Other fatty esters suitable for use in the compositions disclosed herein are mono-carboxylic acid esters of the general formula R′COOR, wherein R′ and R are alkyl or alkenyl radicals, and the sum of carbon atoms in R′and R is at least 10, optionally at least 22.

Still other fatty esters suitable for use in the compositions disclosed herein are di- and tri-alkyl and alkenyl esters of carboxylic acids, such as esters of C₄ to C₈ dicarboxylic acids (e.g. C₁ to C₂₂ esters, optionally C₁ to C_{6,} of succinic acid, glutaric acid, and adipic acid). Specific non-limiting examples of di- and tri- alkyl and alkenyl esters of carboxylic acids include isocetyl stearyol stearate, diisopropyl adipate, and tristearyl citrate.

Other fatty esters suitable for use in the particles disclosed herein are those known as polyhydric alcohol esters. Such polyhydric alcohol esters include alkylene glycol esters, such as ethylene glycol mono and di-fatty acids, diethylene glycol mono- and di-fatty acid esters, polyethylene glycol mono- and di-fatty acid esters, propylene glycol mono- and di-fatty acid esters, polypropylene glycol monooleate, polypropylene glycol 2000 monostearate, ethoxylated propylene glycol monostearate, glyceryl mono- and di-fatty acid esters, polyglycerol poly-fatty acid esters, ethoxylated glyceryl monostearate, 1,3-butylene glycol monostearate, 1,3-butylene glycol distearate, polyoxyethylene polyol fatty acid ester, sorbitan fatty acid esters, and polyoxy-ethylene sorbitan fatty acid esters.

Still other fatty esters suitable for use in the particles disclosed herein are glycerides, including, but not limited to, mono-, di-, and tri-glycerides, optionally di- and tri-glycerides, optionally triglycerides. For use in the compositions described herein, the glycerides are optionally the mono-, di-, and tri-esters of glycerol and long chain carboxylic acids, such as C₁₀ to C₂₂ carboxylic acids. A variety of these types of materials can be obtained from vegetable and animal fats and oils, such as castor oil, safflower oil, cottonseed oil, corn oil, olive oil, cod liver oil, almond oil, avocado oil, palm oil, sesame oil, lanolin and soybean oil. Synthetic oils include, but are not limited to, triolein and tristearin glyceryl dilaurate.

Other fatty esters suitable for use in the particles disclosed herein are water insoluble synthetic fatty esters. Some preferred synthetic esters conform to the general Formula (IX):

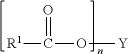

wherein R¹ is a C₇ to C₉ alkyl, alkenyl, hydroxyalkyl or hydroxyalkenyl group, optionally a saturated alkyl group, optionally a saturated, linear, alkyl group; n is a positive integer having a value from 2 to 4, optionally 3; and Y is an alkyl, alkenyl, hydroxy or carboxy substituted alkyl or alkenyl, having from about 2 to about 20 carbon atoms, optionally from about 3 to about 14 carbon atoms. Other preferred synthetic esters conform to the general Formula (X):

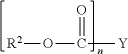

wherein R² is a C₈ to C₁₀ alkyl, alkenyl, hydroxyalkyl or hydroxyalkenyl group; optionally a saturated alkyl group, optionally a saturated, linear, alkyl group; n and Y are as defined above in Formula (X).

Specific non-limiting examples of suitable synthetic fatty esters for use in the particles disclosed herein include: P-43 (C₈-C₁₀ triester of trimethylolpropane), MCP-684 (tetraester of 3,3 diethanol-1,5 pentadiol), MCP 121 (C₈-C₁₀ diester of adipic acid), all of which are available from Mobil Chemical Company.

### Metathesized Unsaturated Polyol Esters

The plurality particles can comprise metathesized Unsaturated Polyol Esters. Exemplary metathesized unsaturated polyol esters and their starting materials are set forth in US 2009/0220443 A1. A metathesized unsaturated polyol ester refers to the product obtained when one or more unsaturated polyol ester ingredient(s) are subjected to a metathesis reaction. Metathesis is a catalytic reaction that involves the interchange of alkylidene units among compounds containing one or more double bonds (i.e., olefinic compounds) via the formation and cleavage of the carbon-carbon double bonds. Metathesis may occur between two of the same molecules (often referred to as self-metathesis) and/or it may occur between two different molecules (often referred to as cross-metathesis).

### Silane-Modified Oils

The plurality of particles can comprise silane-modified oils. In general, suitable silane-modified oils comprise a hydrocarbon chain selected from the group consisting of saturated oil, unsaturated oil, and mixtures thereof; and a hydrolysable silyl group covalently bonded to the hydrocarbon chain. Suitable silane-modified oils are described in detail in U.S. Application Ser. No. 61/821,818, filed May 10, 2013.

### Other Conditioning Agents

The plurality of particles can comprise other conditioning agents as the fabric care benefit agent. Also suitable for use in the particles herein are the conditioning agents described by the Procter & Gamble Company in U.S. Pat. Nos. 5,674,478, and 5,750,122. Also suitable for use herein are those conditioning agents described in U.S. Pat. Nos. 4,529,586 (Clairol), U.S. Pat. No. 4,507,280 (Clairol), U.S. Pat. No. 4,663,158 (Clairol), U.S. Pat. No. 4,197,865 (L'Oreal), U.S. Pat. No. 4,217, 914 (L'Oreal), U.S. Pat. No. 4,381,919 (L'Oreal), and U.S. Pat. No. 4,422, 853 (L'Oreal).

### Quaternary Ammonium Compound

The plurality of particles can comprise quaternary ammonium compound as the fabric care benefit agent. The plurality of particles can comprise a quaternary ammonium compound so that the plurality of particles can provide a softening benefit to laundered fabrics through the wash, and in particular during the wash sub-cycle of a washer having wash and rinse sub-cycles. The quaternary ammonium compound (quat) can be an ester quaternary ammonium compound. Suitable quaternary ammonium compounds include but are not limited to, materials selected from the group consisting of ester quats, amide quats, imidazoline quats, alkyl quats, amidoester quats and combinations thereof. Suitable ester quats include but are not limited to, materials selected from the group consisting of monoester quats, diester quats, triester quats and combinations thereof.

Without being bound by theory, it is thought that the dispersion time of the individual particles that include a quaternary ammonium compound tends to decrease with increasing Iodine Value, recognizing that there is some variability with respect to this relationship.

The plurality of particles can comprise about 5% to about 45% by weight a quaternary ammonium compound. The quaternary ammonium compound can optionally have an Iodine Value from about 18 to about 60, optionally about 18 to about 56, optionally about 20 to about 60, optionally about 20 to about 56, optionally about 20 to about 42, and any whole numbers within the aforesaid ranges. Optionally, the plurality of particles can comprise about 10% to about 40% by weight a quaternary ammonium compound, further optionally having any of the aforesaid ranges of Iodine Value. Optionally, the plurality of particles can comprise about 20% to about 40% by weight a quaternary ammonium compound, further optionally having the aforesaid ranges of Iodine Value.

The quaternary ammonium compound can be selected from the group consisting of esters of bis-(2-hydroxypropyl)-dimethylammonium methylsulfate, isomers of esters of bis-(2-hydroxypropyl)-dimethylammonium methylsulfate and fatty acid, N,N-bis-(stearoyl-2-hydroxypropyl)-N,N-dimethylammonium methylsulfate, esters of bis-(2-hydroxypropyl)-dimethylammonium methylsulfate, of isomers esters of bis-(2-hydroxypropyl)-dimethylammonium methylsulfate, esters of N,N-bis(hydroxyethyl)-N,N-dimethyl ammonium chloride, N,N-bis(stearoyl-oxy-ethyl)-N,N-dimethyl ammonium chloride, esters of N,N,N-tri(2-hydroxyethyl)-N-methyl ammonium methylsulfate, N,N-bis-(palmitoyl-2-hydroxypropyl)-N,N-dimethylammoniu methylsulfate, N,N-bis-(stearoyl-2-hydroxypropyl)-N,N-dimethylammonium chloride, 1,2-di-(stearoyl-oxy)-3-trimethyl ammoniumpropane chloride, dicanoladimethylammonium chloride, di(hard)tallowdimethylammonium chloride, dicanoladimethylammonium methylsulfate, 1-methyl-1-stearoylamidoethyl-2-stearoylimidazolinium methylsulfate, imidazoline quat (no longer used by P&G): 1-tallowylamidoethyl-2-tallowylimidazoline, dipalmitoylmethyl hydroxyethylammonium methylsulfate, dipalmylmethyl hydroxyethylammoinum methylsulfate, 1,2-di(acyloxy)-3-trimethylammoniopropane chloride, and mixtures thereof.

A quaternary ammonium compound can comprise compounds of the formula:

{R²₄₋ₘ—N⁺—[X—Y—R¹]ₘ}A⁻ (1)
wherein:
   m is 1, 2 or 3 with proviso that the value of each m is identical;
   each R¹ is independently hydrocarbyl, or substituted hydrocarbyl group;
   each R² is independently a C₁-C₃ alkyl or hydroxyalkyl group, optionally R² is selected from methyl, ethyl, propyl, hydroxyethyl, 2-hydroxypropyl, 1-methyl-2-hydroxyethyl, poly(C₂₋₃ alkoxy), polyethoxy, benzyl;
   each X is independently (CH₂)n, CH₂—CH(CH₃)— or CH—(CH₃)—CH₂— and
   each n is independently 1, 2, 3 or 4, optionally each n is 2;
   each Y is independently —O—(O)C— or —C(O)—O—;
   A− is independently selected from the group consisting of chloride, methylsulfate, ethylsulfate, and sulfate, optionally A− is selected from the group consisting of chloride and methyl sulfate;
      with the proviso that the sum of carbons in each R¹, when Y is —O—(O)C—, is from 13 to 21, optionally the sum of carbons in each R¹, when Y is —O—(O)C—, is from 13 to 19.

The quaternary ammonium compound can comprise compounds of the formula:

[R3N+CH2CH(YR1)(CH2YR1)]X−

wherein each Y, R, R1, and X− have the same meanings as before. Such compounds include those having the formula:

[CH3]3 N(+)[CH2CH(CH2O(O)CR1)O(O)CR1]C1(−) (2)

wherein each R is a methyl or ethyl group and optionally each R¹ is in the range of C15 to C19. As used herein, when the diester is specified, it can include the monoester that is present.

An example of a preferred DEQA (2) is the “propyl” ester quaternary ammonium fabric softener active having the formula 1,2-di(acyloxy)-3-trimethylammoniopropane chloride. A third type of preferred fabric softening active has the formula:

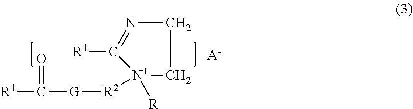

wherein each R, R1, and A− have the definitions given above; each R2 is a C₁-6 alkylene group, optionally an ethylene group; and G is an oxygen atom or an —NR— group;

The quaternary ammonium compound can comprise compounds of the formula:

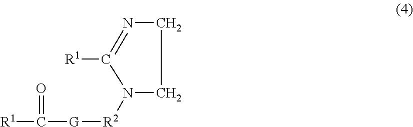

wherein R1, R2 and G are defined as above.

The quaternary ammonium compound can comprise compounds that are condensation reaction products of fatty acids with dialkylenetriamines in, e.g., a molecular ratio of about 2:1, said reaction products containing compounds of the formula:

R1—C(O)—NH—R2-NH-R3-NH—C(O)—R1 (5)

wherein R1, R2 are defined as above, and each R3 is a C1-6 alkylene group, optionally an ethylene group and wherein the reaction products may optionally be quaternized by the additional of an alkylating agent such as dimethyl sulfate.

The quaternary ammonium compound can comprise compounds of the formula:

[R1—C(O)—NR—R2-N(R)2-R3-NR—C(O)—R1]+A− (6)

wherein R, R1, R2, R3 and A− are defined as above;

The quaternary ammonium compound can comprise compounds that are reaction products of fatty acid with hydroxyalkylalkylenediamines in a molecular ratio of about 2:1, said reaction products containing compounds of the formula:

R1—C(O)—NH—R2-N(R3OH)—C(O)—R1 (7)

wherein R1, R2 and R3 are defined as above;

An eighth type of preferred fabric softening active has the formula:

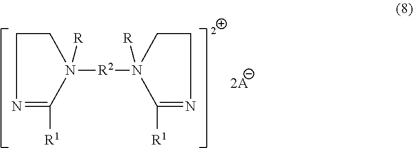

wherein R, R1, R2, and A− are defined as above.

Non-limiting examples of compound (1) are N,N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl) N-(2 hydroxyethyl) N-methyl ammonium methylsulfate.

Non-limiting examples of compound (2) is 1,2 di (stearoyl-oxy) 3 trimethyl ammoniumpropane chloride.

A non-limiting example of Compound (3) is 1-methyl-1-stearoylamidoethyl-2-stearoylimidazolinium methylsulfate wherein R1 is an acyclic aliphatic C15-C17 hydrocarbon group, R2 is an ethylene group, G is a NH group, R5 is a methyl group and A− is a methyl sulfate anion, available commercially from the Witco Corporation under the trade name VARISOFT.

A non-limiting example of Compound (4) is 1-tallowylamidoethyl-2-tallowylimidazoline wherein R1 is an acyclic aliphatic C15-C17 hydrocarbon group, R2 is an ethylene group, and G is a NH group.

A non-limiting example of Compound (5) is the reaction products of fatty acids with diethylenetriamine in a molecular ratio of about 2:1, said reaction product mixture containing N,N″-dialkyldiethylenetriamine with the formula:

R1—C(O)—NH—CH2CH2-NH—CH2CH2-NH—C(O)—R1

wherein R1-C(O) is an alkyl group of a commercially available fatty acid derived from a vegetable or animal source, such as EMERSOL 223LL or EMERSOL 7021, available from Henkel Corporation, and R2 and R3 are divalent ethylene groups.

A non-limiting example of Compound (6) is a difatty amidoamine based softener having the formula:

[R1—C(O)—NH—CH2CH2-N(CH3)(CH2CH2OH)—CH2CH2-NH—C(O)—R1]+CH3SO4-

wherein R1-C(O) is an alkyl group, available commercially from the Witco Corporation e.g. under the trade name VARISOFT 222LT.

An example of Compound (7) is the reaction products of fatty acids with N-2-hydroxyethylethylenediamine in a molecular ratio of about 2:1, said reaction product mixture containing a compound of the formula:

R1—C(O)—NH—CH2CH2-N(CH2CH2OH)—C(O)—R1

wherein R1-C(O) is an alkyl group of a commercially available fatty acid derived from a vegetable or animal source, such as EMERSOL 223LL or EMERSOL 7021, available from Henkel Corporation.

An example of Compound (8) is the diquaternary compound having the formula:

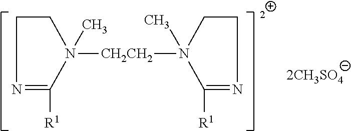

wherein R1 is derived from fatty acid, and the compound is available from Witco Company.

The quaternary ammonium compound can be di-(tallowoyloxyethl)-N,N-methylhydroxyethylammonium methyl sulfate.

It will be understood that combinations of quaternary ammonium compounds disclosed above are suitable for use in the plurality of particles as a fabric care benefit agent.

In the cationic nitrogenous salts herein, the anion A−, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate can be the anion A. The anion can also carry a double charge in which case A− represents half a group.

The plurality of particles can comprise from about 10 to about 40% by weight quaternary compound.

The iodine value of a quaternary ammonium compound is the iodine value of the parent fatty acid from which the compound is formed, and is defined as the number of grams of iodine which react with 100 grams of parent fatty acid from which the compound is formed.

First, the quaternary ammonium compound is hydrolysed according to the following protocol: 25 g of quaternary ammonium compound is mixed with 50 ml of water and 0.3 mL of sodium hydroxide (50% activity). This mixture is boiled for at least an hour on a hotplate while avoiding that the mixture dries out. After an hour, the mixture is allowed to cool down and the pH is adjusted to neutral (pH between 6 and 8) with sulfuric acid 25% using pH strips or a calibrated pH electrode.

Next the fatty acid is extracted from the mixture via acidified liquid-liquid extraction with hexane or petroleum ether: the sample mixture is diluted with water/ethanol (1:1) to 160 mL in an extraction cylinder, 5 grams of sodium chloride, 0.3 mL of sulfuric acid (25% activity) and 50 mL of hexane are added. The cylinder is stoppered and shaken for at least 1 minute. Next, the cylinder is left to rest until 2 layers are formed. The top layer containing the fatty acid in hexane is transferred to another recipient. The hexane is then evaporated using a hotplate leaving behind the extracted fatty acid.

Next, the iodine value of the parent fatty acid from which the fabric softening active is formed is determined following ISO3961:2013. The method for calculating the iodine value of a parent fatty acid comprises dissolving a prescribed amount (from 0.1-3g) into 15 mL of chloroform. The dissolved parent fatty acid is then reacted with 25 mL of iodine monochloride in acetic acid solution (0.1M). To this, 20 mL of 10% potassium iodide solution and 150 mL deionised water is added. After the addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acid enables the iodine value to be calculated.

The quaternary ammonium compound can be that used as part of BOUNCE dryer sheets available from The Procter & Gamble Company, Cincinnati, Ohio, USA. The quaternary ammonium compound can be the reaction product of triethanolamine and partially hydrogenated tallow fatty acids quaternized with dimethyl sulfate.

### Cationic Polymer

The plurality of particles can comprise a cationic polymer as the fabric care benefit agent. Cationic polymers can provide the benefit of a deposition aid that helps to deposit onto the fabric quaternary ammonium compound and possibly some other benefit agents that are contained in the particles.

The plurality of particles can comprise about 0.5% to about 10% by weight cationic polymer. Optionally, the plurality of particles can comprise about 0.5% to about 5% by weight cationic polymer, or even about 1% to about 5% by weight, or even about 2% to about 4% by weight cationic polymer, or even about 3% by weight cationic polymer. Without being bound by theory, it is thought that the cleaning performance of laundry detergent in the wash decreases with increasing levels of cationic polymer in the particles and acceptable cleaning performance of the detergent can be maintained within the aforesaid ranges.

The cationic polymer can have a cationic charge density more than about 0.05 meq/g (meq meaning milliequivalents), to 23 meq/g , optionally from about 0.1 meq/g to about 4 meq/g. optionally from about 0.1 meq/g to about 2 meq/g and optionally from 0.1 meq/g to about 1 meq/g.

The above referenced cationic charge densities can be at the pH of intended use, which can be a pH from about 3 to about 9, optionally about 4 to about 9.

Cationic charge density of a polymer refers to the ratio of the number of positive charges on the polymer to the molecular weight of the polymer. Charge density is calculated by dividing the number of net charges per repeating unit by the molecular weight of the repeating unit. The positive charges may be located on the backbone of the polymers and/or the side chains of polymers. The average molecular weight of such suitable cationic polymers can generally be between about 10,000 and about 10 million, or even between about 50,000 and about 5 million, or even between about 100,000 and about 3 million.

Non-limiting examples of cationic polymers are cationic or amphoteric, polysaccharides, proteins and synthetic polymers. Cationic polysaccharides include cationic cellulose derivatives, cationic guar gum derivatives, chitosan and its derivatives and cationic starches. Cationic polysaccharides have a molecular weight from about 1,000 to about 2 million, optionally from about 100,000 to about 800,000. Suitable cationic polysaccharides include cationic cellulose ethers, particularly cationic hydroxyethylcellulose and cationic hydroxypropylcellulose. Particularly preferred are cationic cellulosic polymers with substituted anhydroglucose units that correspond to the general Structural Formula as follows:

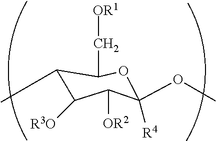

Wherein R¹, R², R³ are each independently selected from H, CH₃, C₈₋₂₄ alkyl (linear or branched),

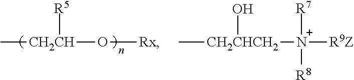

or mixtures thereof;
R⁴ is H,
n is from about 1 to about 10;
Rx is seclected from the group consisting of H, CH₃, C₈₋₂₄ alkyl (linear or branched),

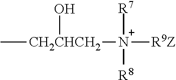

or mixtures thereof, wherein Z is a water soluble anion, optionally a chlorine ion and/or a bromine ion; R⁵ is H, CH₃, CH₂CH₃, or mixtures thereof; R⁷ is CH₃, CH₂CH₃, a phenyl group, a C₈₋₂₄ alkyl group (linear or branched), or mixture thereof; and
R⁸ and R⁹ are each independently CH₃, CH₂CH₃, phenyl, or mixtures thereof:
With the provisio that at least one of R¹, R², R³ groups per anhydroglucose unit is

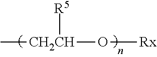

and each polymer has at least one

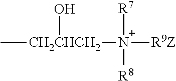

group.

The charge density of the cationic celluloses herein (as defined by the number of cationic charges per 100 anhydroglucose units) is optionally from about 0.5% to about 60%, optionally from about 1% to about 20%, and optionally from about 2% to about 10%.

Alkyl substitution on the anhydroglucose rings of the polymer ranges from about 0.01% to 5% per glucose unit, optionally from about 0.05% to 2% per glucose unit, of the polymeric material.

The cationic cellulose may lightly cross-linked with a dialdehyde such as glyoxyl to prevent forming lumps, nodules or other agglomerations when added to water at ambient temperatures.

Examples of cationic hydroxyalkyl cellulose include those with the INCI name Polyquaternium 10 such as those sold under the trade names UCARE Polymer JR 30M, JR 400, JR 125, LR 400 and LK 400, Polymer PK polymers; Polyquaternium 67 such as those sold under the trade name SOFTCAT SK™, all of which are marketed by Dow Chemicals, Midlad MI, and Polyquaternium 4 such as those sold under the trade name CELQUAT H200 and CELQUAT L-200 available from National Starch and Chemical Company, Bridgewater, NJ. Other suitable polysaccharides include hydroxyethyl cellulose or hydoxypropylcellulose quaternized with glycidyl C₁₂-C₂₂ alkyl dimethyl ammonium chloride. Examples of such polysaccharides include the polymers with the INCI names Polyquaternium 24 such as those sold under the trade name QUATERNIUM LM 200 by Dow Chemicals of Midland, MI. Cationic starches refer to starch that has been chemically modified to provide the starch with a net positive charge in aqueous solution at pH 3. This chemical modification includes, but is not limited to, the addition of amino and/or ammonium group(s) into the starch molecules. Non-limiting examples of these ammonium groups may include substituents such as trimethylhydroxypropyl ammonium chloride, dimethylstearylhydroxypropyl ammonium chloride, or dimethyldodecylhydroxypropyl ammonium chloride. The source of starch before chemical modification can be chosen from a variety of sources including tubers, legumes, cereal, and grains. Non-limiting examples of this source of starch may include corn starch, wheat starch, rice starch, waxy corn starch, oat starch, cassaya starch, waxy barley, waxy rice starch, glutenous rice starch, sweet rice starch, amioca, potato starch, tapioca starch, oat starch, sago starch, sweet rice, or mixtures thereof. Nonlimiting examples of cationic starches include cationic maize starch, cationic tapioca, cationic potato starch, or mixtures thereof. The cationic starches may comprise amylase, amylopectin, or maltodextrin. The cationic starch may comprise one or more additional modifications. For example, these modifications may include cross-linking, stabilization reactions, phophorylations, hydrolyzations, cross-linking. Stabilization reactions may include alkylation and esterification. Suitable cationic starches for use in the present compositions are commercially-available from Cerestar under the trade name C*BOND and from National Starch and Chemical Company under the trade name CATO 2A. Cationic galactomannans include cationic guar gums or cationic locust bean gum. An example of a cationic guar gum is a quaternary ammonium derivative of hydroxypropyl guar such as those sold under the trade name JAGUAR C13 and JAGUAR Excel available from Rhodia, Inc of Cranbury NJ and N-HANCE by Aqualon, Wilmington, DE

Other suitable cationic polymers for use in the plurality of particles include polysaccharide polymers, cationic guar gum derivatives, quaternary nitrogen-containing cellulose ethers, synthetic polymers, copolymers of etherified cellulose, guar and starch. When used, the cationic polymers herein are either soluble in the composition used to form the particles or are soluble in a complex coacervate phase in the composition from which the particles are formed. Suitable cationic polymers are described in U.S. Pat. Nos. 3,962,418; 3,958,581; and U.S. Publication No. 2007/0207109A1.

One group of suitable cationic polymers includes those produced by polymerization of ethylenically unsaturated monomers using a suitable initiator or catalyst, such as those disclosed in WO 00/56849 and U.S. Pat. No. 6,642,200. Suitable cationic polymers may be selected from the group consisting synthetic polymers made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N,N dialkylaminoalkyl acrylate quaternized N,N-dialkylaminoalkyl methacrylate, quaternized N,N-dialkylaminoalkyl acrylamide, quaternized N,N-dialkylaminoalkylmethacrylamide, Methacryloamidopropyl-pentamethyl-1,3-propylene-2-ol-ammonium dichloride, N,N,N,N′,N′,N″,N″-heptamethyl-N″-3-(1-oxo-2-methyl-2- propenyl)aminopropyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride and combinations thereof, and optionally a second monomer selected from the group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glyol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS) and their salts. The polymer may optionally be branched or cross-linked by using branching and crosslinking monomers. Branching and crosslinking monomers include ethylene glycoldiacrylate divinylbenzene, and butadiene. A suitable polyethyleneinine useful herein is that sold under the tradename LUPASOL by BASF, AG, Lugwigschaefen, Germany

In another aspect, the cationic polymer may be selected from the group consisting of cationic polysaccharide, polyethylene imine and its derivatives, poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-Methacryloamidopropyl-pentamethyl-1,3-propylene-2-ol-ammonium dichloride), Suitable cationic polymers include Polyquaternium-1, Polyquaternium-5, Polyquaternium-6, Polyquaternium-7, Polyquaternium-8, Polyquaternium-10, Polyquaternium-11, Polyquaternium-14, Polyquaternium-22, Polyquaternium-28, Polyquaternium-30, Polyquaternium-32 and Polyquaternium-33, as named under the International Nomenclature for Cosmetic Ingredients.

In another aspect, the cationic polymer may comprise polyethyleneimine or a polyethyleneimine derivative. In another aspect, the cationic polymer may comprise a cationic acrylic based polymer. In a further aspect, the cationic polymer may comprise a cationic polyacrylamide. In another aspect, the cationic polymer may comprise a polymer comprising polyacrylamide and polymethacrylamidoproply trimethylammonium cation. In another aspect, the cationic polymer may comprise poly(acrylamide-N-dimethyl aminoethyl acrylate) and its quaternized derivatives. In this aspect, the cationic polymer may be that sold under the tradename SEDIPUR, available from BTC Specialty Chemicals, a BASF Group, Florham Park, N.J. In a yet further aspect, cationic polymer may the comprise poly(acrylamide-co-methacrylamidopropyltrimethyl ammonium chloride). In another aspect, the cationic polymer may comprise a non-acrylamide based polymer, such as that sold under the tradename RHEOVIS CDE, available from Ciba Specialty Chemicals, a BASF group, Florham Park, N.J., or as disclosed in USPA 2006/0252668.

In another aspect, the cationic polymer may be selected from the group consisting of cationic polysaccharides. In one aspect, the cationic polymer may be selected from the group consisting of cationic cellulose ethers, cationic galactomanan, cationic guar gum, cationic starch, and combinations thereof

Another group of suitable cationic polymers may include alkylamine-epichlorohydrin polymers which are reaction products of amines and oligoamines with epicholorohydrin, for example, those polymers listed in, for example, U.S. Pat. Nos. 6,642,200 and 6,551,986. Examples include dimethylamine-epichlorohydrin-ethylenediamine, available under the trade name CARTAFIX CB, CARTAFIX TSF, available from Clariant, Basle, Switzerland.

Another group of suitable synthetic cationic polymers may include polyamidoamine-epichlorohydrin (PAE) resins of polyalkylenepolyamine with polycarboxylic acid. The most common PAE resins are the condensation products of diethylenetriamine with adipic acid followed by a subsequent reaction with epichlorohydrin. They are available from Hercules Inc. of Wilmington DE under the trade name KYMENE from BASF AG (Ludwigshafen, Germany) under the trade name LURESIN.

The cationic polymers may contain charge neutralizing anions such that the overall polymer is neutral under ambient conditions. Non-limiting examples of suitable counter ions (in addition to anionic species generated during use) include chloride, bromide, sulfate, methylsulfate, sulfonate, methylsulfonate, carbonate, bicarbonate, formate, acetate, citrate, nitrate, and mixtures thereof.

The weight-average molecular weight of the cationic polymer may be from about 500 to about 5,000,000, or from about 1,000 to about 2,000,000, or from about 5000 to about 1,000,000 Daltons, as determined by size exclusion chromatography relative to polyethyleneoxide standards with RI detection. In one aspect, the weight-average molecular weight of the cationic polymer may be from about 100,000 to about 800,000 Daltons.

The cationic polymer can be provided in a powder form. The cationic polymer can be provided in an anhydrous state.

### Fatty Acid

The plurality of particles can comprise fatty acid as the fabric care benefit agent. The term “fatty acid” is used herein in the broadest sense to include unprotonated or protonated forms of a fatty acid. One skilled in the art will readily appreciate that the pH of an aqueous composition will dictate, in part, whether a fatty acid is protonated or unprotonated. The fatty acid may be in its unprotonated, or salt form, together with a counter ion, such as, but not limited to, calcium, magnesium, sodium, potassium, and the like. The term “free fatty acid” means a fatty acid that is not bound to another chemical moiety (covalently or otherwise).

The fatty acid may include those containing from 12 to 25, from 13 to 22, or even from 16 to 20, total carbon atoms, with the fatty moiety containing from 10 to 22, from 12 to 18, or even from 14 (mid-cut) to 18 carbon atoms.

The fatty acids may be derived from (1) an animal fat, and/or a partially hydrogenated animal fat, such as beef tallow, lard, etc .; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, etc.; (3) processed and/or bodied oils, such as linseed oil or tung oil via thermal, pressure, alkali-isomerization and catalytic treatments; (4) combinations thereof, to yield saturated (e.g. stearic acid), unsaturated (e.g. oleic acid), polyunsaturated (linoleic acid), branched (e.g. isostearic acid) or cyclic (e.g. saturated or unsaturated α-disubstituted cyclopentyl or cyclohexyl derivatives of polyunsaturated acids) fatty acids.

Mixtures of fatty acids from different fat sources can be used.

The cis/trans ratio for the unsaturated fatty acids may be important, with the cis/trans ratio (of the C_{18:1} material) being from at least 1:1, at least 3:1, from 4:1 or even from 9:1 or higher. Branched fatty acids such as isostearic acid are also suitable since they may be more stable with respect to oxidation and the resulting degradation of color and odor quality. The fatty acid may have an iodine value from 0 to 140, from 50 to 120 or even from 85 to 105.

The plurality of particles can comprise from about 1% to about 40% by weight fatty acid. The fatty acid can be selected from the group consisting of, a saturated fatty acids, unsaturated fatty acid, and mixtures thereof. The fatty acid can be a blend of saturated fatty acids, a blend of unsaturated fatty acids, and mixtures thereof. The fatty acid can be substituted or unsubstituted. The fatty acid can be provided with the quaternary ammonium compound. The fatty acid can have an Iodine Value of zero.

The fatty acid can be selected from the group consisting of stearic acid, palmitic acid, coconut oil, palm kernel oil, stearic acid palmitic acid blend, oleic acid, vegetable oil, partially hydrogenated vegetable oil, and mixtures thereof.

The fatty acid can be Stearic acid CAS No. 57-11-4. The fatty acid can be palmitic acid CAS No. 57-10-3. The fatty acid can be a blend of stearic acid and coconut oil.

The fatty acid can be C12 to C22 fatty acid. C12 to C22 fatty acid can have tallow or vegetable origin, can be saturated or unsaturated, can be substituted or unsubstituted.

Without being bound by theory, fatty acid may help as a processing aid for uniformly mixing the formulation components of the individual particles constituting the plurality of particles.

### Branched Polyester

The plurality of particles can comprise branched polyester as the fabric care benefit agent. The plurality of particles can comprise about 5% to about 45% by weight of a branched polyester selected from the group of:
(i) a branched polyester having Formula 1

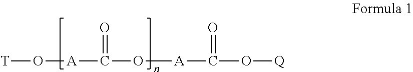

wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to about 100;
(ii) a branched polyester having Formula 2

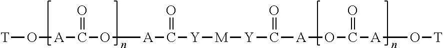

### Formula 2

each n is independently an integer from 1 to about 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group consisting of oxygen and NR₂, wherein each R₂ is independently selected from the group consisting of hydrogen, or a C₁-C₈ alkyl; and
M is a polyalkylene glycol group;
(iii) and mixtures thereof; and
   optionally a deposition aid;
   wherein each of the particles has a mass from about 1 mg to about 1 g; and
   wherein the particles have an onset of melt from about 25° C. to about 120° C. is disclosed.

They polyhydroxystearic acid of Formula 1 can be HYPERMER LP1, available from Croda Inc & Sederma Inc., Edison, New Jersey, United States of America. They polyhydroxystearic acid of Formula 1 can be SALACOS HS-4C, available from Nisshin Oillio Group, Ltd., Tokyo, Japan. They polyhydroxystearic acids of Formula 2 can be HYPERMER B261, HYPERMER B210, and HYPERMER B246, available from Croda Inc & Sederma Inc., Edison, New Jersey, United States of America.

The plurality of particles can comprise by weight, from about 10% to about 40%, optionally from about 3% to about 35%, optionally from 4% to 30% of a branched polyester selected from the group consisting of:
(i) the branched polyester of the Formula 1

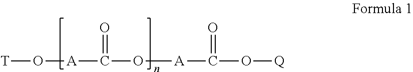

wherein:
each A is independently a branched hydrocarbon chain comprising from 4 to 40 carbon atoms, optionally from 12 to 20 carbon atoms, optionally 17 carbon atoms
Q is selected from an alkyl chain comprising 1 to 30 carbon atoms and a hydrogen atom, optionally Q is a hydrogen atom;
T is a hydrogen atom or a —C(O)—R wherein each R is an alkyl chain comprising from 7 to 21 carbon atoms, optionally from 11 to 17 carbon atoms; and
n is an integer from 4 to 40, optionally n is an integer from 5 to 20;
(ii) the branched polyester of the Formula 2

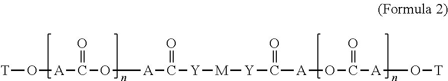

wherein:
n is an integer from 4 to 40, optionally n is an integer from 5 to 20
each A is independently a branched hydrocarbon chain comprising from 4 to 40 carbon atoms, optionally from 12 to 20 carbon atoms, optionally 17 carbon atoms
each T is independently a hydrogen atom or a —C(O)—R wherein each R is an alkyl chain comprising from 7 to 21 carbon atoms, optionally from 11 to 17 carbon atoms;
each Y is independently a linking group selected from the group consisting of oxygen and NR₂, wherein each R₂ is independently selected from the group consisting of hydrogen, or a C₁-C₈ alkyl, optionally each R₂ is hydrogen;
M is a polyalkylene glycol group, optionally M has the structure

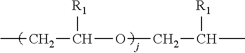

wherein
   each R₁ is selected from hydrogen, methyl and ethyl;
   j is an integer from 0 to about 400, optionally from 2 to about 50;
(iv) and mixtures thereof.

The branched polyester polymer having Formula 1 and Formula 2 can each have a weight average molecular weight of from about 500 g/mol to about 100,000 g/mol, optionally from about 1000 g/mol to about 60,000 g/mol, optionally from about 1000 g/mol to about 10,000 g/mol, optionally from about 1000 g/mol to about 5,000 g/mol, is disclosed.

Each A of the polyester polymers can be independently a branched hydrocarbon having the structure

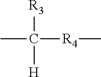

wherein each R₃ is a monovalent alkyl or substituted alkyl group and R₄ is an unsaturated or saturated divalent alkylene radical comprising from 1 to about 24 carbon atoms, optionally each R₃ is a monovalent alkyl radical comprising 6 carbon atoms and each R₄ is an unsaturated or saturated divalent alkylene radical comprising from 10 carbon atoms.
Each A of the polyester polymers can have the structure:

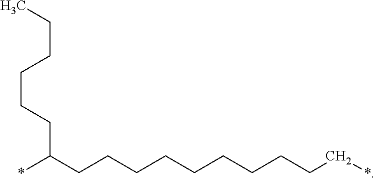

The branched polyester polymer can have an iodine value from about 0 to about 90, optionally from about 0.4 to about 50 optionally from about 1 to about 30, is disclosed.

### Fatty Amine

The plurality of particles can comprise a fatty amine as the fabric care benefit agent. The fatty amine can be of the structure:

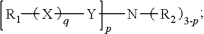

wherein each R₁ is independently selected from the group consisting of C₈-C₃₂ alkyl, C₈-C₃₂ substituted alkyl, C₆-C₃₂ aryl, C₅-C₃₂ substituted aryl, C₆-C₃₂ alkylaryl, C₆-C₃₂ substituted alkylaryl;
X is a

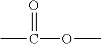

group or a

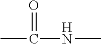

group;
Y is an alkylene radical having 1-6 carbon atoms; N is a nitrogen atom; R₂ is independently selected from the group consisting of H, C₁-C₆ alkyl, hyroxyalkyl and polyhydroxyalkyl; q is 0 or 1; and p is an integer from 1-3.

Optionally, each R₁ is independently C₁₀-C₂₂ alkyl or C₈-C₂₂ substituted alkyl;
X is the

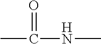

group; Y is an alkylene radical having 2-4 carbon atoms; R₂ is independently H or C₁-C₆ alkyl; q is 1; and p is 1.

Optionally, each R₁ is independently C₁₀-C₂₂ alkyl and R₂ is a methyl group

The fatty amine can be of the structure

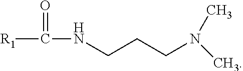

Optionally, R₁ is a C₁₂-C₂₂ alkyl; X is a

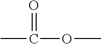

group; Y is an alkylene radical with 2-4 carbon atoms; R₂ is independently selected from the group consisting of H, C₁-C₆ alkyl, hyroxyalkyl and polyhydroxyalkyl groups; q=1; and p=1 to 3.

The fatty amine can have a structure selected from the group consisting of:

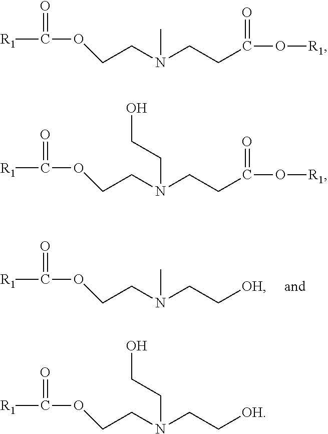

Optionally each R₁ is independently C₁₀-C₁₈ alkyl; Y is an alkylene radical with 2-4 carbon atoms, R₂ is independently selected from the group consisting of H, C₁-C₆ alkyl, hyroxyalkyl and polyhydroxyalkyl groups, p is an integer from 1-3 and q=0
Optionally, R₂ is a methyl or hydroxyethyl group;

The fatty amine can have a structure selected from the group consisting of:

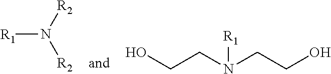

The fatty amine can be selected from the group consisting of: fatty esters of bis-(2-hydroxypropyl)-methylamine, bis-(hydroxyethyl)-methyl amine, bis-(hydroxyethyl)-isopropyl amine and triethanolamine with at least one fatty acid comprising C₁₂-C₂₂ alkyl chain; N,N-bis-(stearoyl-2-hydroxypropyl)-N-methylamine; N,N-bis(stearoyl-oxy-ethyl)-N-methyl amine; N,N-bis(stearoyl-oxy-ethyl)-N-hydroxyethylamine; N-(stearoyl-oxy-ethyl)-N, N-dimethyl amine; N-(stearoyl-oxy-ethyl)-N, N-hydroxyethylamine; N,N,N-tris(stearoyl-oxy-ethyl)-amine; stearylamidopropyl dimethyl amine; cocoamidopropyl dimethylamine; behenylamidopropyl dimethyl amine; stearylamine; distearylamine; tristearylamine; N, N-distearyl N-methylamine, and combinations thereof.

The plurality of particles of the fabric softening composition can comprise about 5% to about 45% by weight the fatty amine. Optionally, the plurality of particles of the fabric softening composition can comprise about 8% to about 35% by weight, optionally about 10% to about 35% by weight, optionally about 12% to about 30% by weight, optionally about 15% to about 25% by weight the fatty amine. The fatty amine and the weight fraction of the fatty amine in the plurality of particles can affect dissolution time of the plurality of particles.

### Graft Copolymer

The particles can comprise a suspension graft copolymer as the fabric care benefit agent. Broadly, the graft copolymer may comprise and/or be obtainable by grafting (a) a polyalklyene oxide with (b) a vinyl ester. A first graft copolymer is described in more detail below.

The particles may include from about 1% to about 75%, or to about 50%, or to about 25%, or from about 1% to about 20%, or from about 1% to about 15%, or from about 2% to about 10%, or from about 1% to about 7%, optionally from about 1% to about 30%, by weight of the particles, of the graft copolymer. The graft copolymer may be present in an aqueous treatment liquor, such as a wash liquor or a rinse liquor of an automatic washing machine, in an amount of about 5 ppm, or from about 10 ppm, or from about 25 ppm, or from about 50 ppm, to about 1500 ppm, or to about 1000 ppm, or to about 500 ppm, or to about 250 ppm.

The graft copolymer may be comprise and/or be obtainable by grafting (a) a polyalkylene oxide which has a number average molecular weight of from about 1000 to about 20000 Da, or to about 15000 Da, or to about 12000 Da, or to about 10000 Da and is based on ethylene oxide, propylene oxide, or butylene oxide, optionally based on ethylene oxide, with (b) a vinyl ester derived from a saturated monocarboxylic acid containing from 1 to 6 carbon atoms, optionally a vinyl ester that is vinyl acetate or a derivative thereof; where the weight ratio of (a):(b) is from about 1:0.1 to about 1:2;

The graft copolymer may be obtainable by grafting (a) an alkylene oxide which has a number average molecular weight of from about 1000 to 20000 Da, or to about 15000, or to about 12000 Da, or to about 10000 Da, the alkylene oxide being based on ethylene oxide, with (b) vinyl acetate or a derivative thereof, wherein the number of grafting sites is less than 1 per 50 ethylene oxide groups, wherein the composition is a fabric care composition.

The graft bases used may be the polyalkylene oxides specified above under (a). The polyalkylene oxides of component (a) may have a number average molecular weight of about 300 Da, or from about 1000 Da, or from about 2000 Da, or from about 3000 Da, to about 20000 Da, or to about 15000 Da, or to about 12000, Da or to about 10000 Da, or to about 8000 Da, or to about 6000 Da. Without wishing to be bound by theory, it is believed that if the molecular weight of component (a) (e.g., polyethylene glycol), is relatively low, there may be a performance decrease in dye transfer inhibition. Additionally or alternatively, when the molecular weight is too high, the polymer may not remain suspended in solution and/or may deposit on treated fabrics.

The polyalkylene oxides may be based on ethylene oxide, propylene oxide, butylene oxides, or mixtures thereof, optionally ethylene oxide. The polyalkylene oxides may be based on homopolymers of ethylene oxide or ethylene oxide copolymers having an ethylene oxide content of from about 40 to about 99 mole %. Suitable comonomers for such copolymers may include propylene oxide, n-butylene oxide, and/or isobutylene oxide. Suitable copolymers may include copolymers of ethylene oxide and propylene oxide, copolymers of ethylene oxide and butylene oxide, and/or copolymers of ethylene oxide, propylene oxide, and at least one butylene oxide. The copolymers may include an ethylene oxide content of from about 40 to about 99 mole %, a propylene oxide content of from about 1 to about 60 mole %, and a butylene oxide content of from about 1 to about 30 mole %. The graft base may be linear (straight-chain) or branched, for example a branched homopolymer and/or a branched copolymer.

Branched copolymers may be prepared by addition of ethylene oxide with or without propylene oxides and/or butylene oxides onto polyhydric low molecular weight alcohols, for example trimethylol propane, pentoses, or hexoses. The alkylene oxide unit may be randomly distributed in the polymer or be present therein as blocks.

The polyalkylene oxides of component (a) may be the corresponding polyalkylene glycols in free form, that is, with OH end groups, or they may be capped at one or both end groups. Suitable end groups may be, for example, C1-C25-alkyl, phenyl, and C1-C14-alkylphenyl groups. The end group may be a C1-alkyl (e.g., methyl) group. Suitable materials for the graft base may include PEG 300, PEG 1000, PEG 2000, PEG 4000, PEG 6000, PEG 8000, and/or PEG 10,000 which are polyethylene glycols, and/or MPEG 2000, MPEG 4000, MPEG 6000, MPEG 8000 and MEG 10000 which are monomethoxypolyethylene glycols that are commercially available from BASF under the tradename PLURIOL.

The polyalkylene oxides may be grafted with a vinyl ester as the monomer of component (b). The vinyl ester may be derived from a saturated monocarboxylic acid, which may contain 1 to 6 carbon atoms, or from 1 to 3 carbon atoms, or from 1 to 2 carbon atoms, or 1 carbon atom. Suitable vinyl esters may include vinyl formate, vinyl acetate, vinyl propionate, vinyl butyrate, vinyl valerate, vinyl iso-valerate, vinyl caproate, or mixtures thereof. Preferred monomers of component (b) include those selected from the group consisting of vinyl acetate, vinyl propionate, methyl acrylate, mixtures of vinyl acetate, or mixtures thereof, optionally vinyl acetate. The monomers of the graft copolymer, e.g., components (a) and (b) may be present in certain ratios, such as weight ratios and/or mole ratios.

The weight ratio of (a):(b) may be greater than 1:1, or from about 1:0.1 to about 1:0.8, or from about 1:0.1 to about 1:2, or from about 1:0.1 to about 1:1.5, or from about 1:0.2 to about 1:0.6. The weight ratio of (a):(b) can be from about 1:0.1 to about 1:4, or to about 1:3 or to about 1:2. The amount, by weight, of (a) may be greater than the amount of (b). Without wishing to be bound by theory, it is believed that relatively high levels of component (b) (e.g., vinyl acetate), particularly in relation to component (a), may result in relatively greater hydrophobicity, which can lead to formulation and/or stability challenges.

The graft copolymers of the present disclosure may be characterized by relatively low degree of branching (i.e., degree of grafting). In the graft copolymers of the present disclosure, the average number of grafting sites may be less than or equal to 1, or less than or equal to 0.8, or less than or equal to 0.6, or less than or equal to 0.5, or less than or equal to 0.4, per 50 alkylene oxide groups, e.g., ethylene oxide groups. The graft copolymers may comprise, on average, based on the reaction mixture obtained, at least 0.05, or at least 0.1, graft site per 50 alkylene oxide groups, e.g., ethylene oxide groups. The degree of branching may be determined, for example, by means of ¹³C NMR spectroscopy from the integrals of the signals of the graft sites and the —CH₂-groups of the polyakylene oxide. The number of grafting sites may be adjusted by manipulating the temperature and/or the feed rate of the monomers. For example, the polymerization may be carried out in such a way that an excess of component (a) and the formed graft copolymer is constantly present in the reactor. For example, the quantitative molar ratio of component (a) and polymer to ungrafted monomer (and initiator, if any) is generally greater than or equal to about 10:1, or to about 15:1, or to about 20:1.

The graft copolymers of the present disclosure may be characterized by a relatively narrow molar mass distribution. For example, the graft copolymers may be characterized by a polydispersity M_{w}/Mₙ of less than or equal to about 3, or less than or equal to about 2.5, or less than or equal to about 2.3. The polydispersity of the graft copolymers may be from about 1.5 to about 2.2. The polydispersity may be determined by gel permeation chromatography using narrow-distribution polymethyl methacrylates as the standard.

The graft copolymers may be prepared by grafting the suitable polyalkylene oxides of component (a) with the monomers of component (b) in the presence of free radical initiators and/or by the action of high-energy radiation, which may include the action of high-energy electrons. This may be done, for example, by dissolving the polyalkylene oxide in at least one monomer of group (b), adding a polymerization initiator and polymerizing the mixture to completion. The graft polymerization may also be carried out semicontinuously by first introducing a portion, for example 10%, of the mixture of polyalkylene oxide to be polymerized, at least one monomer of group (b) and initiator, heating to polymerization temperature and, after the polymerization has started, adding the remainder of the mixture to be polymerized at a rate commensurate with the rate of polymerization. The graft copolymers may also be obtained by introducing the polyalkylene oxides of group (a) into a reactor, heating to the polymerization temperature, and adding at least one monomer of group (b) and polymerization initiator, either all at once, a little at a time, or uninterruptedly, optionally uninterruptedly, and polymerizing.

Any suitable polymerization initiator(s) may be used, which may include organic peroxides such as diacetyl peroxide, dibenzoyl peroxide, succinyl peroxide, di-tert-butyl peroxide, tert-butyl perbenzoate, tert-butyl perpivalate, tert-butyl permaleate, cumene hydroperoxide, diisopropyl peroxodicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl peracetate, di-tert-amyl peroxide, tert-butyl hydroperoxide, mixtures thereof, redox initiators, and/or azo starters. The choice of initiator may be related to the choice of polymerization temperature.

The graft polymerization may take place at from about 50° C. to about 200° C., or from about 70° ° C. to about 140° C. The graft polymerization may typically be carried out under atmospheric pressure, but may also be carried out under reduced or superatmospheric pressure.

The graft polymerization may be carried out in a solvent. Suitable solvents may include: monohydric alcohols, such as ethanol, propanols, and/or butanols; polyhydric alcohols, such as ethylene glycol and/or propylene glycol; alkylene glycol ethers, such as ethylene glycol monomethyl and -ethyl ether and/or propylene glycol monomethyl and -ethyl ether; polyalkylene glycols, such as di- or tri-ethylene glycol and/or di- or tri-propylene glycol; polyalkylene glycol monoethers, such as poly(C2-C3-alkylene)glycol mono (C1-C16-alkyl)ethers having 3-20 alkylene glycol units; carboxylic esters, such as ethyl acetate and ethyl propionate; aliphatic ketones, such as acetone and/or cyclohexanone; cyclic ethers, such as tetrahydrofuran and/or dioxane; or mixtures thereof.

The graft polymerization may also be carried out in water as solvent. In such cases, the first step may be to introduce a solution which, depending on the amount of added monomers of component (b), is more or less soluble in water. To transfer water-insoluble products that can form during the polymerization into solution, it is possible, for example, to add organic solvents, for example monohydric alcohols having 1 to 3 carbon atoms, acetone, and/or dimethylformamide. In a graft polymerization process in water, it is also possible to transfer the water-insoluble graft copolymers into a finely divided dispersion by adding customary emulsifiers or protective colloids, for example polyvinyl alcohol. The emulsifiers used may be ionic or nonionic surfactants whose HLB value is from about 3 to about 13. HLB value is determined according to the method described in the paper by W.C. Griffin in J. Soc. Cosmet. Chem. 5 (1954), 249.

The amount of surfactant used in the graft polymerization process may be from about 0.1 to about 5% by weight of the graft copolymer. If water is used as the solvent, solutions or dispersions of graft copolymers may be obtained. If solutions of graft copolymers are prepared in an organic solvent or in mixtures of an organic solvent and water, the amount of organic solvent or solvent mixture used per 100 parts by weight of the graft copolymer may be from about 5 to about 200, optionally from about 10 to about 100, parts by weight.

The graft copolymers may have a K value of from about 5 to about 200, optionally from about 5 to about 50, determined according to H. Fikentscher (Cellulosechemie, 1932, 13, 58) in 2% strength by weight solution in dimethylformamide at 25 C.

After the graft polymerization, the graft copolymer may optionally be subjected to a partial hydrolysis. The graft copolymer may include up to 60 mole %, or up to 50 mole %, or up to 40 mole %, or up to 25 mole %, or up to 20 mole %, or up to 15 mole %, or up to 10 mole %, of the grafted-on monomers of component (b) are hydrolyzed. For instance, the hydrolysis of graft copolymers prepared using vinyl acetate or vinyl propionate as component (b) gives graft copolymers containing vinyl alcohol units. The hydrolysis may be carried out, for example, by adding a base, such as sodium hydroxide solution or potassium hydroxide solution, or alternatively by adding acids and if necessary heating the mixture. Without wishing to be bound by theory, it is believed that increasing the level of hydrolysis of component (b) increases the relative hydrophilicity of the graft copolymer.

A suitable amphilic graft co-polymer is SOKALAN HP22, supplied from BASF. Suitable polymers include random graft copolymers, optionally a polyvinyl acetate grafted polyethylene oxide copolymer having a polyethylene oxide backbone and multiple polyvinyl acetate side chains. The molecular weight of the polyethylene oxide backbone is typically about 6000 Da and the weight ratio of the polyethylene oxide to polyvinyl acetate is about 40 to 60 and no more than 1 grafting point per 50 ethylene oxide units.

The graft copolymer can be a graft copolymer VAc-gPEG4000 available from BASF, Ludwigshafen, Germany. Synthesis of graft copolymer VAc-gPEG4000 is described in WO 01/05874.

A second graft copolymer is described as follows. The graft copolymer may comprise and/or be obtainable by grafting (a) a polyalklyene oxide with (b) N-vinylpyrrolidone and (c) a vinyl ester. The graft copolymer is described in more detail below.

The graft copolymer may comprise and/or be obtainable by grafting (a) a polyalkylene oxide which has a number average molecular weight of from about 1000 to about 20000 Da, or to about 15000, or to about 12000 Da, or to about 10000 Da and is based on ethylene oxide, propylene oxide, or butylene oxide, optionally based on ethylene oxide, with (b) N-vinylpyrrolidone, and further with (c) a vinyl ester derived from a saturated monocarboxylic acid containing from 1 to 6 carbon atoms, optionally a vinyl ester that is vinyl acetate or a derivative thereof; where the weight ratio of (a):(b) is from about 1:0.1 to about 1:1; where the amount, by weight, of (a) is greater than the amount of (c); and where the order of the addition of monomers (b) and (c) in the graft polymerization is immaterial.

The graft copolymer may comprise and/or be obtainable by grafting (a) an alkylene oxide which has a number average molecular weight of from about 1000 to 20000 Da, or to about 15000, or to about 12000 Da, or to about 10000 Da, the alkylene oxide being based on ethylene oxide, with (b) N-vinylpyrrolidone, and (c) vinyl acetate or a derivative thereof; wherein the weight ratio of (a):(b) is from about 1:0.1 to about 1:2, or to about 1:1; wherein the weight ratio of (b):(c) is from about 1:0.1 to about 1:5, or to about 1:4; wherein the weight ratio of (a):(c) is from about 1:0.1 to about 1:5, or to about 1:3; the order of the addition of monomers (b) and (c) in the graft polymerization being immaterial.

The graft copolymer may be obtainable by grafting (a) an alkylene oxide which has a number average molecular weight of from about 1000 to 20000 Da, or to about 15000, or to about 12000 Da, or to about 10000 Da, the alkylene oxide being based on ethylene oxide, with (b) N-vinylpyrrolidone, and (c) vinyl acetate or a derivative thereof, the order of the addition of monomers (b) and (c) in the graft polymerization being immaterial, wherein the number of grafting sites is less than 1 per 50 ethylene oxide groups.

The graft bases used may be the polyalkylene oxides specified above under (a). The polyalkylene oxides of component (a) may have a number average molecular weight of about 300, or from about 1000 Da, or from about 2000 Da, or from about 3000, to about 20000 Da, or to about 15000, or to about 12000 Da, or to about 10000 Da, or to about 8000 Da, or to about 6000 Da. Without wishing to be bound by theory, it is believed that if the molecular weight of component (a) (e.g., polyethylene glycol), is relatively low, there may be a performance decrease in dye transfer inhibition. Additionally or alternatively, when the molecular weight is too high, the polymer may not remain suspended in solution and/or may deposit on treated fabrics.

The polyalkylene oxides may be grafted with N-vinylpyrrolidone as the monomer of component (b). Without wishing to be bound by theory, it is believed that the presence of the N-vinylpyrrolidone (“VP”) monomer in the graft copolymers according to the present disclosure provides water-solubility and good film-forming properties compared to otherwise-similar polymers that do not contain the VP monomer. The vinyl pyrrolidone repeat unit has amphiphilic character with a polar amide group that can form a dipole, and a non-polar portion with the methylene groups in the backbone and the ring, making it hydrophobic. When the vinyl pyrrolidone content is too high, there may be negative effects on softness and material cost is high with high vinyl pyrrolidone content.

The polyalkylene oxides may be grafted with a vinyl ester as the monomer of component (c). The vinyl ester may be derived from a saturated monocarboxylic acid, which may contain 1 to 6 carbon atoms, or from 1 to 3 carbon atoms, or from 1 to 2 carbon atoms, or 1 carbon atom. Suitable vinyl esters may be selected from the group consisting of vinyl formate, vinyl acetate, vinyl propionate, vinyl butyrate, vinyl valerate, vinyl iso-valerate, vinyl caproate, or mixtures thereof. Preferred monomers of component (c) include those selected from the group consisting of vinyl acetate, vinyl propionate, or mixtures thereof, optionally vinyl acetate. The monomers of the graft copolymer, e.g., components (a), (b), and/or (c), may be present in certain ratios, such as weight ratios and/or mole ratios.

For example, the weight ratio of (a):(b) may be from about 1:0.1 to about 1:1, or from about 1:0.2 to about 1:0.7. The weight ratio of (a):(b) may be from about 1:0.1 to about 1:2, or to about 1:1. When the VP ratio is too high, the polymer may form negative interactions with other composition ingredients and/or may not work sufficiently on some hydrolyzed reactive dyes.

The weight ratio of (a):(c) may be greater than 1:1, or from about 1:0.1 to about 1:0.8, or from about 1:0.2 to about 1:0.6. The weight ratio of (a):(c) is from about 1:0.1 to about 1:5, or to about 1:3. The amount, by weight, of (a) may be greater than the amount of (c). Without wishing to be bound by theory, it is believed that relatively high levels of component (c) (e.g., vinyl acetate), particularly in relation to component (a), may result in decreased performance of dye transfer inhibition and/or relatively greater hydrophobicity, which can lead to formulation and/or stability challenges.

The weight ratio of (b):(c) may be from about 1:0.1 to about 1:5, or to about 1:4. Without wishing to be bound by theory, a ratio of VP-to-VAc that is too high may lead to higher deposition on fabric causing the treated fabric to have a negative feel. Additionally, negative interactions with ingredients such as brighteners may occur.

The graft copolymers may be prepared by grafting the suitable polyalkylene oxides of component (a) with the monomers of component (b) in the presence of free radical initiators and/or by the action of high-energy radiation, which may include the action of high-energy electrons. This may be done, for example, by dissolving the polyalkylene oxide in at least one monomer of group (b), adding a polymerization initiator and polymerizing the mixture to completion. The graft polymerization may also be carried out semicontinuously by first introducing a portion, for example 10%, of the mixture of polyalkylene oxide to be polymerized, at least one monomer of group (b) and/or (c) and initiator, heating to polymerization temperature and, after the polymerization has started, adding the remainder of the mixture to be polymerized at a rate commensurate with the rate of polymerization. The graft copolymers may also be obtained by introducing the polyalkylene oxides of group (a) into a reactor, heating to the polymerization temperature, and adding at least one monomer of group (b) and/or (c) and polymerization initiator, either all at once, a little at a time, or uninterruptedly, optionally uninterruptedly, and polymerizing.

After the graft polymerization, the graft copolymer may optionally be subjected to a partial hydrolysis. The graft copolymer may include up to 60 mole %, or up to 50 mole %, or up to 40 mole %, or up to 25 mole%, or up to 20 mole %, or up to 15 mole %, or up to 10 mole %, of the grafted-on monomers of component (c) are hydrolyzed. For instance, the hydrolysis of graft copolymers prepared using vinyl acetate or vinyl propionate as component (c) gives graft copolymers containing vinyl alcohol units. The hydrolysis may be carried out, for example, by adding a base, such as sodium hydroxide solution or potassium hydroxide solution, or alternatively by adding acids and if necessary heating the mixture. Without wishing to be bound by theory, it is believed that increasing the level of hydrolysis of component (c) increases the relative hydrophilicity of the graft copolymer, which in turn is believed to result in better suspension of the captured dyes.

### Perfume

The plurality of particles can comprise perfume as the fabric care benefit agent. The plurality of particles may comprise a free perfume and/or an encapsulated perfume as the fabric care benefit agent. Perfumes are generally described in U.S. Pat. No. 7,186,680 at column 10, line 56, to column 25, line 22.

Suitable encapsulated perfumes can include: U.S. Patent Publication Nos. 2003215417 A1; 2003216488 A1; 2003158344 A1; 2003165692 A1; 2004071742 A1; 2004071746 A1; 2004072719 A1; 2004072720 A1; 2003203829 A1; 2003195133 A1; 2004087477 A1; and 20040106536 A1; U.S. Pat. Nos. 6,645,479; 6,200,949; 4,882,220; 4,917,920; 4,514,461; and 4,234,627; and U.S. Re. 32,713, and European Patent Publication EP 1393706 A1.

The encapsulated perfume can comprise a melamine/formaldehyde shell. Encapsulated perfume may be obtained from Appleton, Quest International, or International Flavor & Fragrances, or other suitable source. In one embodiment, the encapsulate is coated with polymer to enhance the ability of the encapsulate to adhere to fabric, as describe in U.S. Pat. Nos. 7,125,835; 7,196,049; and 7,119,057.

Optionally, the plurality of particles can comprise perfume carrier materials (and perfume contained therein). Examples of perfume carrier materials are described in U.S. Pat. No. 7,186,680, column 25, line 23, to column 31, line 7.

Encapsulated perfume can be perfume oil enclosed within a shell. The shell can have an average shell thickness less than the maximum dimension of the perfume core. The encapsulates can be friable encapsulates. The encapsulates, if present, can be moisture activated encapsulates.

The plurality of particles can comprise from about 0.1% to about 10% by weight encapsulated perfume, optionally from about 0.3% to about 5% by weight encapsulated perfume, optionally from about 0.5% to about 3% by weight encapsulated perfume. The plurality of particles can comprise from about 0.1% to about 15% by weight free perfume, optionally from about 0.3% to about 10% by weight free perfume, optionally from about 0.5% to about 8% by weight free perfume.

### Dye

The plurality of particles may comprise dye. The dye may include those dyes that are typically used in laundry detergent or fabric softeners. The plurality of particles may comprise less than about 0.1%, alternatively about 0.001% to about 0.1%, alternatively about 0.01% to about 0.02%, alternatively combinations thereof and any hundredths of percent or ranges of hundredths of percent within any of the aforementioned ranges, of dye by weight of the plurality of particles. Examples of suitable dyes include, but are not limited to, LIQUITINT PINK AM, AQUA AS CYAN 15, and VIOLET FL, available from Milliken Chemical. Employing a dye can be practical to help the user differentiate between particles having differing scents.

### Particles

The plurality of particles can comprise about 25% to 99% by weight a carrier system. The one or more fabric care benefit agents can be dispersed in a matrix of the carrier system. The plurality of particles can comprise from about 35% to about 95%, optionally from about 50% to about 80%, optionally combinations thereof and any whole percentages or ranges of whole percentages within any of the aforementioned ranges, of carrier system. The plurality of particles can comprise individual particles that comprise about 25% to about 99% by weight of individual particles carrier system.

The particles can each have a mass from about 1 mg to about 500 mg, alternatively from about 5 mg to about 500 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg. An individual particle may have a volume from about 0.003 cm³ to about 5 cm³, optionally from about 0.003 cm³ to about 1 cm³, optionally from about 0.003 cm³ to about 0.5 cm³, optionally from about 0.003 cm³ to about 0.2 cm³, optionally from about 0.003 cm³ to about 0.15 cm³. Smaller particles are thought to provide for better packing of the particles in a container and faster dissolution in the wash. The plurality of particles can comprise less than 10% by weight of particles having an individual mass less than about 10 mg. This can reduce the potential for dust.

The particles disclosed herein, in any of the embodiments or combinations disclosed, can have a shape selected from spherical, hemispherical, oblate spherical, cylindrical, polyhedral, and oblate hemisphere. The particles may be hemispherical, compressed hemispherical, or have at least one substantially flat or flat surface. Such particles may have relatively high surface area to mass as compared to spherical particles. Dissolution time in water may decrease as a function of increasing surface area, with shorter dissolution time being preferred over longer dissolution time.

The particles disclosed herein can have ratio of maximum dimension to minimum dimension from about 10 to 1, optionally from about 8 to 1, optionally about 5 to 1, optionally about 3 to 1, optionally about 2 to 1. The particles disclosed herein can be shaped such that the particles are not flakes. Particles having a ratio of maximum dimension to minimum dimension greater than about 10 or that are flakes can tend to be fragile such the particles are prone to becoming dusty. The fragility of the particles tends to decrease with decreasing values of the ratio of maximum dimension to minimum dimension.

The plurality of particles can comprise less than about 20% by weight anionic surfactant, optionally less than about 10% by weight anionic surfactant, optionally less than about 5% by weight anionic surfactant, optionally less than about 3% by weight anionic surfactant, optionally less than about 1% by weight anionic surfactant. The plurality of particles can comprise from 0 to about 20%, optionally from 0 to about 10%, optionally from about 0 to about 5%, optionally from about 0 to about 3%, optionally from about 0 to about 1% by weight anionic surfactant. Providing an antioxidant in particles that have little or no anionic surfactant can be practical for limiting micelle development around the fabric care benefit agent which might hinder deposition of the fabric care benefit agent on the fabric.

The plurality of particles can comprise less than about 10% by weight water. The individual particles of the plurality of particles can have a particles onset of melt from about 40 C to about 55 C. Such particles may be stable within the supply chain from manufacturer to the consumer's household.

The particles can comprise bubbles of gas. The bubbles of gas can be spherical bubbles of gas. Since the particles can include bubbles of gas entrained therein, the particles can have a density that is less than the density or weighted average density of the constitutive solid and or liquid materials forming the particles. It can be advantageous for particles that include bubbles of gas to include an antioxidant since the bubbles of gas may contribute to oxidation reactions within the particle. Each of the particles can have a density less than about 1 g/cm³. Optionally, the particles can have a density less than about 0.98 g/cm³. Optionally, the particles can have a density less than about 0.95 g/cm³. Since the density of a typical washing solution is about 1 g/cm³, it can be desirable to provide particles that have a density less than about 1 g/cm³ or even less than about 0.95 g/cm³. Particles that have a density less than about 1 g/cm³ can be desirable for providing for particles 90 that float in a wash liquor.

Each of the particles can have a volume and the occlusions of gas within the particles 90 can comprise between about 0.5% to about 50% by volume of the particle, or even between about 1% to about 20% by volume of the particle, or even between about 2% to about 15% by volume of the particle, or event between about 4% to about 12% by volume of the particle. Without being bound by theory, it is thought that if the volume of the occlusions of gas is too great, the particles may not be sufficiently strong to be packaged, shipped, stored, and used without breaking apart in an undesirable manner.

The occlusions can have an effective diameter between about 1 micron to about 2000 microns, or even between about 5 microns to about 1000 microns, or even between about 5 microns to about 200 microns, or even between about 25 to about 50 microns. In general, it is thought that smaller occlusions of gas are more desirable than larger occlusions of gas. If the effective diameter of the occlusions of gas are too large, it is thought that the particles might not be sufficiently strong to be to be packaged, shipped, stored, and used without breaking apart in an undesirable manner. The effective diameter is diameter of a sphere having the same volume as the occlusion of gas. The occlusions of gas can be spherical occlusions of gas.

### EXAMPLES

### Example 1

### Half-lives (DT50) of Inventive and Comparative Examples

Degradation is the process by which a chemical substance is broken down into smaller molecules by biotic means (biodegradability) or abiotic means (hydrolysis, photolysis, or oxidization). Half-lives (DT50) are used as measures of the stability and persistence of a chemical substance in the environment. Half-life (DT50) is defined as the time it takes for an amount of a compound to be reduced by half through degradation. It is crucial for the environmental impact, especially in the Persistent, Bioaccumulative, and Toxic (PBT) assessment. Chemicals with low aquatic DT50 values are less likely to persist in aquatic environments.

Using the Quantitative Water Persistence model [1,2] in the VEGA-Toolkit, the DT50 in water predictions for the inventive and comparative compound are 7 days and 82 days, respectively (Table 1 below)

TABLE 1

| Example | Structure n = 15 | DT50 in water (Days) |
|---|---|---|
| Inventive 1 | 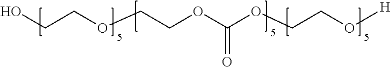 | 7 |
| Comparative 1 | 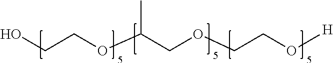 | 82 |

[1] M. Floris, A. Manganaro, O. Nicolotti, R. Medda, G. F. Mangiatordi, and E. Benfenati, A Generalizable Definition of Chemical Similarity for Read-Across, Journal of Cheminformatics 6, 39 (2014).
[2] T. Gouin, I. Cousins, and D. Mackay, Comparison of Two Methods for Obtaining Degradation Half-Lives, Chemosphere 56, 531 (2004).

### Example 2

A plurality of particles could have 73% by weight a carrier system of polyalkylenecarbonate compound (II)

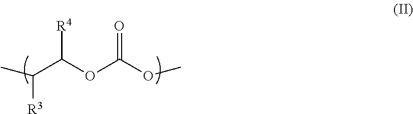

wherein, R³ and R⁴ are each independently selected from H and CH₃;
20% by weight starch; 0.5% antimicrobial; 1% by weight encapsulated perfume; and
5.5% by weight free perfume. The plurality of particles are contained in a container.

### Combinations

An example is below:
A. A composition comprising a plurality of particles, said plurality of particles comprising: about 5% to about 99.9% by weight, optionally from 10% to about 99% by weight, optionally from about 30% by weight to about 95% by weight of a carrier system comprising polyalkylenecarbonate compound (II)

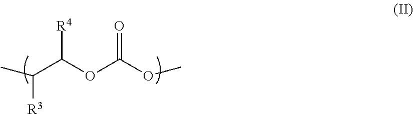

wherein, R₃ and R₄ are each independently selected from H and CH₃; and
a fabric care benefit agent selected from the group of:
starch;
modified starch;
enzyme;
silicone materials;
organic conditioning oils;
fatty esters;
metathesized unsaturated polyol esters;
silane-modified oils;
quaternary ammonium compound;
branched polyester;
fatty amine;
graft copolymer;
antioxidant;
antimicrobial; and
mixtures thereof.
B. The composition according to Paragraph A, wherein said carrier system further comprises a carrier material selected from the group of:
polyalkylene polymer of formula H—(C₂H₄O)ₓ—(CH(CH₃)CH₂O)_{y}—(C₂H₄O)_{z}—OH wherein x is from 50 to 300, y is from 20 to 100, and z is from 10 to 200;
polyethylene glycol fatty acid ester of formula (C₂H₄O)_{q}—C(O)O—(CH₂)ᵣ—CH₃ wherein q is from 20 to 200 and r is from 10 to 30;
polyethylene glycol fatty alcohol ether of formula HO—(C₂H₄O)ₛ—(CH₂)ₜ)—CH₃ wherein s is from 30 to 250 and t is from 10 to 30;
C8-C22 alkyl polyalkoxylate comprising more than 40 alkoxylate units;
polyethylene glycol having a weight average molecular weight from 2000 to 15000;
EO/PO/EO block copolymer;
PO/EO/PO block copolymer;
EO/PO block copolymer;
PO/EO block copolymer;
polypropylene glycol;
ethoxylated nonionic surfactant having a degree of ethoxylation greater than 30;
polyvinyl alcohol;
polyalkylene glycol having a weight average molecular weight from 2000 to 15000;
water soluble organic alkali metal salt;
water soluble inorganic alkaline earth metal salt;
water soluble organic alkaline earth metal salt;
water soluble carbohydrate;
water soluble silicate;
water soluble urea;
starch;
clay;
water insoluble silicate;
citric acid;
carboxymethyl cellulose;
fatty acid
fatty alcohol;
glyceryl diester of hydrogenated tallow;
glycerol;
polyethylene glycol;
and mixtures thereof.
C. The composition according to Paragraph A or B, wherein said carrier system further comprises a carrier material selected from the group of polyvinyl alcohol, modified polyvinyl alcohol, polyvinyl pyrrolidone, polyvinyl alcohol/polyvinyl pyrrolidone, polyvinyl alcohol/polyvinyl amine, partially hydrolyzed polyvinyl acetate, polyalkylene oxide, polyethylene glycol, acrylamide, acrylic acid, cellulose, alkyl cellulosics, methyl cellulose, ethyl cellulose, propyl cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides, starch, modified starch, gelatin, alginates, xyloglucans, hemicellulosic polysaccharides, xylan, glucuronoxylan, arabinoxylan, mannan, glucomannan, galactoglucomannan, natural gums, pectin, xanthan, carrageenan, locus bean, arabic, tragacanth, polyacrylates, sulfonated polyacrylates, water-soluble acrylate copolymers, alkylhydroxy cellulosics, methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates, polyvinyl alcohol copolymers, hydroxypropyl methyl cellulose, and mixtures thereof.
D. The composition according to any of Paragraphs A to C, wherein said carrier system further comprises a carrier material selected from the group of: sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof.
E. The composition according to any of Paragraphs A to D, wherein said carrier system further comprises a salt hydrate.
F. The composition according to any of Paragraphs A to E, wherein said particles have a density less than about 1 g/cm³.
G. The composition according to any of Paragraphs A to F, wherein said fabric care benefit agent comprises starch, wherein said starch has a dextrose equivalent from 0 to about 40, optionally from 0 to about 20.
H. The composition according to any of Paragraphs A to G, wherein said fabric care benefit agent comprises enzyme, wherein said enzyme is selected from the group of care enzyme, nuclease, and combinations thereof.
I. The composition according to any of Paragraphs A to H, wherein said fabric care benefit agent comprises quaternary ammonium compound, wherein said quaternary ammonium compound is formed from a parent fatty acid compound having an lodine Value from 18 to 60, optionally from 20 to 60, optionally from 20 to 56, optionally from 20 to 42, optionally from 20 to 35.
J. The composition according to any of Paragraphs A to I, wherein said fabric care benefit agent comprises quaternary ammonium compound, wherein said quaternary ammonium compound is an ester quaternary ammonium compound.
K. The composition according to any of Paragraphs A to J, wherein said fabric care benefit agent comprises quaternary ammonium compound, wherein said quaternary ammonium compound is di-(tallowoyloxyethl)-N,N-methylhydroxyethylammonium methyl sulfate.
L. The composition according to any of Paragraphs A to K, wherein said plurality of particles further comprise a cationic polymer.
M. The composition according to any of Paragraphs A to L, wherein said fabric care benefit agent comprises a branched polyester selected from the group consisting of:
   a) a branched polyester having Formula 1

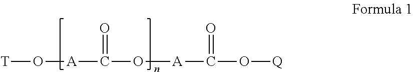

wherein:
each A is independently a branched hydrocarbon chain comprising 4 to 100 carbon atoms;
Q is selected from an alkyl chain comprising 1 to 30 carbon atoms and a hydrogen atom;
T is a hydrogen atom or a —C(O)—R wherein each R is an alkyl chain comprising 1 to 30 carbon atoms; and
n is an integer from 1 to 100;
b) a branched polyester having Formula 2

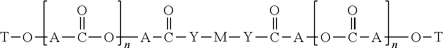

each n is independently an integer from 1 to 100;
each A is independently a branched hydrocarbon chain comprising 4 to 100 carbon atoms;
each T is independently a hydrogen atom or a —C(O)—R wherein each R is an alkyl chain comprising 1 to 30 carbon atoms;
each Y is independently a linking group selected from the group consisting of oxygen and NR₂, wherein each R₂ is independently selected from the group consisting of hydrogen, or a C₁-C₈ alkyl; and
M is a polyalkylene glycol group;
c) and mixtures thereof.
N. The composition according to any of Paragraphs A to L, wherein said fabric care benefit agent comprises a branched polyester selected from the group consisting of:
   a) the branched polyester of the Formula 1

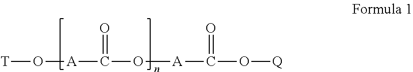

wherein:
each A is independently a branched hydrocarbon chain comprising from 4 to 40 carbon atoms, optionally from 12 to 20 carbon atoms, optionally 17 carbon atoms;
Q is selected from an alkyl chain comprising 1 to 30 carbon atoms and a hydrogen atom, optionally Q is a hydrogen atom;
T is a hydrogen atom or a —C(O)—R wherein each R is an alkyl chain comprising from 7 to 21 carbon atoms, optionally from 11 to 17 carbon atoms; and
n is an integer from 4 to 40, optionally n is an integer from 5 to 20;
b) the branched polyester of the Formula 2

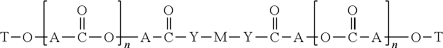

wherein:
n is an integer from 4 to 40, optionally n is an integer from 5 to 20 each A is independently a branched hydrocarbon chain comprising from 4 to 40 carbon atoms, optionally from 12 to 20 carbon atoms, optionally 17 carbon atoms;
each T is independently a hydrogen atom or a —C(O)—R wherein each R is an alkyl chain comprising from 7 to 21 carbon atoms, optionally from 11 to 17 carbon atoms;
each Y is independently a linking group selected from the group consisting of oxygen and NR₂, wherein each R₂ is independently selected from the group consisting of hydrogen, or a C₁-C₈ alkyl, optionally each R₂ is hydrogen;
M is a polyalkylene glycol group, optionally M has the structure

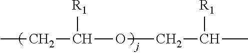

wherein
   each R₁ is selected from hydrogen, methyl and ethyl;
   j is an integer from 0 to 400, optionally from 2 to 50;
c) and mixtures thereof.
O. The composition according to Paragraph M, wherein each A of said branch polyester has the structure:

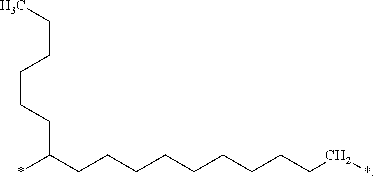

P. The composition according to any of Paragraphs A to O, wherein said fabric care benefit agent comprises a fatty amine of the structure:

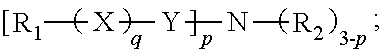

wherein each R₁ is independently selected from the group consisting of C₈-C₃₂ alkyl, C₈-C₃₂ substituted alkyl, C₆-C₃₂ aryl, C₅-C₃₂ substituted aryl, C₆-C₃₂ alkylaryl, C₆-C₃₂ substituted alkylaryl;
X is a

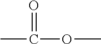

group or a

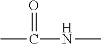

group;
Y is an alkylene radical having 1-6 carbon atoms;
N is a nitrogen atom;
R₂ is independently selected from the group consisting of H, C₁-C₆ alkyl, hyroxyalkyl and polyhydroxyalkyl;
q is 0 or 1;
p is an integer from 1-3; and
wherein said plurality of particles comprises individual particles, wherein said individual particles each have a mass from 1 mg to 1 g.
Q. The composition according to Paragraph P, wherein said fatty amine is selected from the group consisting of dimethylamidopropyl stearamide, esters of bis-(2-hydroxypropyl)-methylamine, bis-(hydroxyethyl)-methyl amine, bis-(hydroxyethyl)-isopropyl amine and triethanolamine with at least one fatty acid comprising C₁₂-C₂₂ alkyl chain; N,N-bis(stearoyl-oxy-ethyl)-N-hydroxyethylamine; N,N-bis-(stearoyl-2-hydroxypropyl)-N-methylamine; N,N-bis(stearoyl-oxy-ethyl)-N-methyl amine; N, N- bis(stearoyl-oxy-ethyl)-N-hydroxyethylamine; N-(stearoyl-2-hydroxypropyl)-N,N-dimethylamine; N-(stearoyl-oxy-ethyl)-N,N-dimethyl amine; N-(stearoyl-oxy-ethyl)-N, N-hydroxyethylamine; N,N,N-tris(stearoyl-oxy-ethyl)-amine; and combinations thereof.
R. The composition according to any of Paragraphs A to Q, wherein said fabric care benefit agent comprises a graft copolymer, wherein said graft copolymer comprises:
   (a) a polyalkylene oxide which has a number average molecular weight of from 1000 to 20000 Da and is based on ethylene oxide, propylene oxide, or butylene oxide; and
   (b) a vinyl ester derived from a saturated monocarboxylic acid containing from 1 to 6 carbon atoms;
wherein (a) and (b) are present at a weight ratio of (a):(b) of from 1:0.1 to 1:2.
S. The composition according to any of Paragraphs A to Q, wherein said fabric care benefit agent comprises a graft copolymer, wherein said graft copolymer comprises
   (a) a polyalkylene oxide which has a number average molecular weight of from about 1000 to about 20000 Da and is based on ethylene oxide, propylene oxide, or butylene oxide;
   (b) a N-vinylpyrrolidone; and
   (c) a vinyl ester derived from a saturated monocarboxylic acid containing from 1 to 6 carbon atoms;
wherein (a) and (b) are present at a weight ratio of (a):(b) of from about 1:0.1 to about 1:1;
wherein by weight, (a) is present in an amount greater than (c);
wherein order of addition of (b) and (c) in graft polymerization is immaterial.
T. The composition according to any of Paragraphs A to S, wherein said fabric care benefit agent comprises antioxidant selected from the group of:
alkylated phenols having the formula of

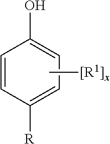

wherein R¹ is a C₃-C₆ branched alkyl, optionally tert-butyl;
x is 1 or 2, optionally x is 2; at least one R¹ is ortho to the OH group, optionally when x is 2, both R¹ are ortho to the OH group;
R is selected from —OH, C₂-C₂₂ linear alkyl, C₃-C₂₂ branched alkyl, and (CₙH₂ₙ)_{y}(CO₂)R², where the index n is 1 to 6, optionally n is 1 to 3, optionally n is 2, the index y is 0 or 1, optionally y is 1;
R² is selected from C₁-C₈ linear alkyl, C₃-C₈ branched alkyl, and (CₘH₂ₘO)_{z}R³ where each m is independently 1 to 4, optionally each m is independently 2 or 3, the index z is 1 to 20, R³ is
H or C₁-C₄ linear alkyl; optionally R² is C₁-C₁₈ linear alkyl or C₃-C₁₈ branched alkyl, optionally
R² is C₁-C₄ linear alkyl or C₃-C₈ branched alkyl, optionally R² is methyl;
alkylated phenols having the formula of

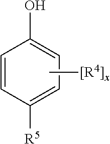

wherein x is 1 or 2, optionally 2;
each R⁴ is independently selected from C₁-C₆ linear alkyl, and C₃-C₁₆ branched alkyl, provided when x is 2, at least one R⁴ in the alkylated phenol is not t-butyl, optionally C₁-C₆ linear alkyl, optionally methyl; optionally one R⁴ is C₃-C₁₆ branched alkyl, optionally t-butyl; optionally, one R⁴ is methyl and the other R⁴ is t-butyl;
wherein at least one R⁴ is positioned on the ring ortho to a hydroxyl group, optionally both R⁴ are ortho to a hydroxyl group;
R⁵ is selected from C₁-C₂₂ linear alkyl, C₃-C₂₂ branched alkyl, (CᵣH₂ᵣO)_{w}R⁹ where each r is independently 1 to 4, the index w is 1 to 20, R⁹ is H or C₁-C₄ linear alkyl, and (CₙH₂ₙ)_{y}C(O)QR⁶, where Q is independently selected from —O—, —S—, and —NR⁷—, wherein R⁷ is selected from H and
C₁-C₄ alkyl, optionally R⁷ is H; where the index n is 1 to 6, optionally n is 2 or 3, the index y is 0 or 1, optionally 1; optionally R⁵ is (CₙH₂ₙ)_{y}C(O)QR⁶ wherein Q is —O—, n is 2 or 3, and y is 1; R⁶ is selected from C₁-C₈ linear alkyl, C₃-C₈ branched alkyl, and GR⁸ wherein G is a divalent organic moiety with weight from 12 to 1,443 Da, optionally from 12 to 300, optionally G is selected from (CH₂)ₚQ where the index p is from 2 to 12 and (CₘH₂ₘO)_{z}, where each m is independently 1 to 4, optionally m is 2 or 3, optionally m is 2, the index z is 1 to 20; optionally G is (CₘH₂ₘO)_{z}, where each m is 2, the index z is 2 to 6; R⁸ is H, C₁-C₄ linear alkyl, C(O)(CₙH₂ₙ)_{y}C₆H₄(R⁴)ₓOH, and mixtures thereof, wherein n, y, x and R⁴, which are independently selected for R⁸, are defined as above;
alkylated phenols having the formula of

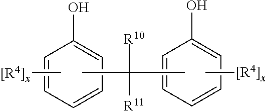

wherein each index x is independently 1 or 2;
each R⁴ is independently selected from C₁-C₆ linear alkyl, optionally methyl, and C₃-C₁₆ branched alkyl, optionally t-butyl; wherein each R⁴ is positioned either ortho- or para- to the OH group on its ring, and wherein the two points of attachment of the —CR¹⁰R¹¹— bridge are ortho-, para-, or a mixture thereof, optionally both either ortho- or both para-, to the OH on the aryl rings to which the bridge is joined; R¹⁰ and R¹¹ are individually selected from H and C₁-C₆ linear alkyl, optionally H and methyl, optionally R¹⁰ and R¹¹ are H;
aryl amines;
and mixtures thereof.
U. The composition according to any of Paragraphs A to T wherein the polyalkylenecarbonate compound has a molecular weight of from 120 to 200000, optionally from 150 to 150000, optionally from 200 to 100000, optionally from 250 to 50000, optionally from 300 to 25000, optionally from 350 to 15000, optionally from 400 to 10000, optionally from 450 to 9000, optionally from 500 to 8000.
V. The composition according to any of Paragraphs A to U, wherein the total weight percentage of CO₂ (CO₂ wt %) in the polyalkylenecarbonate compound is from 5% to 70%, optionally from 10% to 60%, optionally from 15% to 55%, optionally from 20% to 50%, most preferable form 25% to 45%.
W. The composition according to any of Paragraphs A to V, wherein the polyalkylenecarbonate compound has the following structure (I):

R¹{-L-[A]ₓ-[B]_{y}—R²}_{z} - - - (I)
wherein,
R¹ is a residue derived from a starter compound,
   wherein the starter compound is selected from monofunctional starter compound comprising from 1 to 4 carbon atoms, difunctional starter compound, and multifunctional starter compound;
R² is each independently selected from H, linear or branched, substituted or unsubstituted C₁-C₄ alkyl;
L is selected from O, (C═O)—O, a single bond;
A has the following structural unit (II)

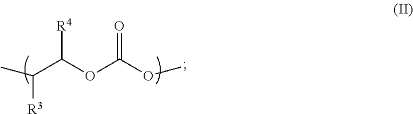

B has the following structural unit (III)

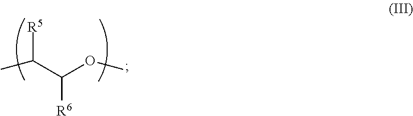

R³, R⁴, R⁵, R⁶ are each independently selected from H and CH₃;
x is integer each independently in the range of 1 to 250;
y is integer each independently in the range of 0 to 250;
z is integer each independently in the range of 1 to 20;
X. The composition according to any of Paragraphs A to W, wherein said fabric care benefit agent comprises silicone, wherein said silicone comprises a terminal aminosilicone or a polydimethylsiloxane.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising a plurality of particles, said plurality of particles comprising:
about 5% to about 99.9% by weight of a carrier system comprising polyalkylenecarbonate compound (II) 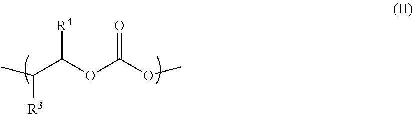
wherein, R³ and R⁴ are each independently selected from H and CH₃; and
a fabric care benefit agent selected from the group of:
starch;
modified starch;
enzyme;
silicone materials;
organic conditioning oils;
fatty esters;
metathesized unsaturated polyol esters;
silane-modified oils;
quaternary ammonium compound;
branched polyester;
fatty amine;
graft copolymer;
antioxidant; and
antimicrobial.

2. The composition according to claim 1, wherein said fabric care benefit agent comprises starch, wherein said starch has a dextrose equivalent from 0 to about 40.

3. The composition according to claim 1, wherein said fabric care benefit agent comprises enzyme, wherein said enzyme is selected from the group of care enzyme, nuclease, and combinations thereof.

4. The composition according to claim 1, wherein said plurality of particles further comprise a cationic polymer.

5. The composition according to claim 1, wherein said fabric care benefit agent comprises quaternary ammonium compound, wherein said quaternary ammonium compound is formed from a parent fatty acid compound having an Iodine Value from 18 to 60.

6. The composition according to claim 5, wherein said plurality of particles further comprise a cationic polymer.

7. The composition according to claim 1, wherein said fabric care benefit agent comprises a branched polyester, wherein said branched polyester is selected from the group of:
a) the branched polyester of the Formula 1 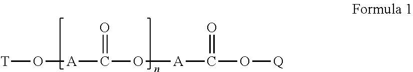
wherein:
each A is independently a branched hydrocarbon chain comprising from 4 to 40 carbon atoms;
Q is selected from an alkyl chain comprising 1 to 30 carbon atoms and a hydrogen atom;
T is a hydrogen atom or a —C(O)—R wherein each R is an alkyl chain comprising from 7 to 21 carbon atoms; and
n is an integer from 4 to 40;
b) the branched polyester of the Formula 2 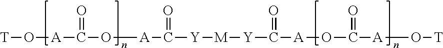
wherein:
n is an integer from 4 to 40;
each A is independently a branched hydrocarbon chain comprising from 4 to 40 carbon atoms;
each T is independently a hydrogen atom or a —C(O)—R wherein each R is an alkyl chain comprising from 7 to 21 carbon atoms;
each Y is independently a linking group selected from the group consisting of oxygen and NR₂, wherein each R₂ is independently selected from the group consisting of hydrogen, or a C₁-C₈ alkyl;
M is a polyalkylene glycol group;
c) and mixtures thereof.

8. The composition according to claim 7, wherein said plurality of particles further comprise a cationic polymer.

9. The composition according to claim 8, wherein each A of said branch polyester has the structure:

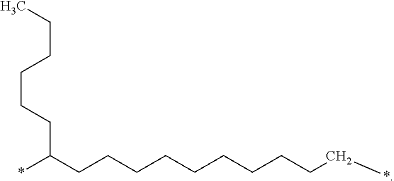

10. The composition according to claim 1, wherein said fabric care benefit agent comprises a fatty amine of the structure: 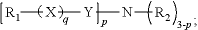
wherein each R₁ is independently selected from the group consisting of C₈-C₃₂ alkyl, C₈-C₃₂ substituted alkyl, C₆-C₃₂ aryl, C₅-C₃₂ substituted aryl, C₆-C₃₂ alkylaryl, C₆-C₃₂ substituted alkylaryl;
X is a 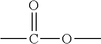
group or a 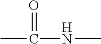
group;
Y is an alkylene radical having 1-6 carbon atoms;
N is a nitrogen atom;
R₂ is independently selected from the group consisting of H, C₁-C₆ alkyl, hyroxyalkyl and polyhydroxyalkyl;
q is 0 or 1;
p is an integer from 1-3; and
wherein said plurality of particles comprises individual particles, wherein said individual particles each have a mass from 1 mg to 1 g.

11. The composition according to claim 1, wherein said fatty amine is selected from the group consisting of dimethylamidopropyl stearamide, esters of bis-(2-hydroxypropyl)-methylamine, bis-(hydroxyethyl)-methyl amine, bis-(hydroxyethyl)-isopropyl amine and triethanolamine with at least one fatty acid comprising C₁₂-C₂₂ alkyl chain; N,N-bis(stearoyl-oxy-ethyl)-N-hydroxyethylamine; N,N-bis-(stearoyl-2-hydroxypropyl)-N-methylamine; N,N-bis(stearoyl-oxy-ethyl)-N-methyl amine; N,N-bis(stearoyl-oxy-ethyl)-N-hydroxyethylamine; N-(stearoyl-2-hydroxypropyl)-N,N-dimethylamine; N-(stearoyl-oxy-ethyl)-N,N-dimethyl amine; N-(stearoyl-oxy-ethyl)-N,N-hydroxyethylamine; N,N,N-tris(stearoyl-oxy-ethyl)-amine; and combinations thereof.

12. The composition according to claim 1, wherein said fabric care benefit agent comprises a graft copolymer, wherein said graft copolymer comprises:
(a) a polyalkylene oxide which has a number average molecular weight of from 1000 to 20000 Da and is based on ethylene oxide, propylene oxide, or butylene oxide; and
(b) a vinyl ester derived from a saturated monocarboxylic acid containing from 1 to 6 carbon atoms;
wherein (a) and (b) are present at a weight ratio of (a):(b) of from 1:0.1 to 1:2.

13. The composition according to claim 1, wherein said fabric care benefit agent comprises a graft copolymer, wherein said graft copolymer comprises:
(a) a polyalkylene oxide which has a number average molecular weight of from about 1000 to about 20000 Da and is based on ethylene oxide, propylene oxide, or butylene oxide;
(b) a N-vinylpyrrolidone; and
(c) a vinyl ester derived from a saturated monocarboxylic acid containing from 1 to 6 carbon atoms;
wherein (a) and (b) are present at a weight ratio of (a):(b) of from about 1:0.1 to about 1:1;
wherein by weight, (a) is present in an amount greater than (c);
wherein order of addition of (b) and (c) in graft polymerization is immaterial.

14. The composition according to claim 13, wherein said plurality of particles further comprise a cationic polymer.

15. The composition according to claim 1, wherein said fabric care benefit agent comprises antioxidant selected from the group of:
alkylated phenols having the formula of 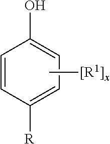
wherein R¹ is a C₃-C₆ branched alkyl;
x is 1 or 2; at least one R¹ is ortho to the OH group;
R is selected from —OH, C₂-C₂₂ linear alkyl, C₃-C₂₂ branched alkyl, and (CₙH₂ₙ)_{y}(CO₂)R², where the index n is 1 to 6;
R² is selected from C₁-C₈ linear alkyl, C₃-C₈ branched alkyl, and (CₘH₂ₘO)_{z}R³ where each m is independently 1 to 4;
alkylated phenols having the formula of 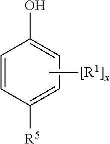
wherein x is 1 or 2;
each R⁴ is independently selected from C₁-C₆ linear alkyl, and C₃-C₁₆ branched alkyl, provided when x is 2, at least one R⁴ in the alkylated phenol is not t-butyl;
wherein at least one R⁴ is positioned on the ring ortho to a hydroxyl group;
R⁵ is selected from C₁-C₂₂ linear alkyl, C₃-C₂₂ branched alkyl, (CᵣH₂ᵣO)_{w}R⁹ where each r is independently 1 to 4, the index w is 1 to 20, R′ is H or C₁-C₄ linear alkyl, and (CₙH₂ₙ)_{y}C(O)QR⁶, where Q is independently selected from —O—, —S—, and —NR⁷—, wherein R⁷ is selected from H and C₁-C₄ alkyl; where the index n is 1 to 6; R⁶ is selected from C₁-C₈ linear alkyl, C₃-C₈ branched alkyl, and GR⁸ wherein G is a divalent organic moiety with weight from 12 to 1,443 Da; R⁸ is H, C₁-C₄ linear alkyl, C(O)(CₙH₂ₙ)_{y}C₆H₄(R⁴)ₓOH, and mixtures thereof, wherein n, y, x and R⁴, which are independently selected for R⁸, are defined as above;
alkylated phenols having the formula of 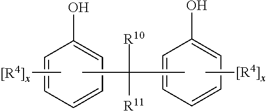
wherein each index x is independently 1 or 2;
each R⁴ is independently selected from C₁-C₆ linear alkyl, and C₃-C₁₆ branched alkyl; wherein each R⁴ is positioned either ortho- or para- to the OH group on its ring, and wherein the two points of attachment of the —CR¹⁰R¹¹— bridge are ortho-, para-, or a mixture thereof; R¹⁰ and R¹¹ are individually selected from H and C₁-C₆ linear alkyl;
aryl amines;
and mixtures thereof.

16. The composition according to claim 1, wherein the polyalkylenecarbonate compound has a molecular weight of from 120 to 200000.

17. The composition according to claim 1, wherein the total weight percentage of CO₂ (CO₂ wt %) in the polyalkylenecarbonate compound is from 5% to 70%.

18. The composition according to claim 1, wherein the polyalkylenecarbonate compound has the following structure (I):
R¹{-L-[A]ₓ-[B]_{y}—R²}_{z} - - - (I)
Wherein,
R¹ is a residue derived from a starter compound,
wherein the starter compound is selected from monofunctional starter compound comprising from 1 to 4 carbon atoms, difunctional starter compound, and multifunctional starter compound;
R² is each independently selected from H, linear or branched, substituted or unsubstituted C₁-C₄ alkyl;
L is selected from O, (C—O)—O, a single bond;
A has the following structural unit (II) 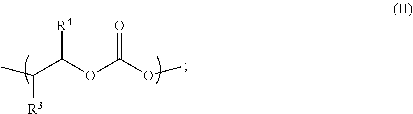
B has the following structural unit (III) 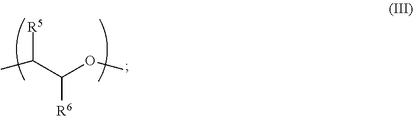
R³, R⁴, R⁵, R⁶ are each independently selected from H and CH₃;
X is integer each independently in the range of 1 to 250;
y is integer each independently in the range of 0 to 250;
Z is integer each independently in the range of 1 to 20.

19. The composition according to claim 1, wherein the total weight percentage of CO₂ (CO₂ wt %) in the polyalkylenecarbonate compound is from 25% to 45%.

20. The composition according to claim 1, wherein the polyalkylenecarbonate compound has a molecular weight of from 500 to 8000.
